(19) United States
(12) Patent Application Publication
(10) Pub. No.: US 2015/0081454 A1
(43) Pub. Date: Mar. 19, 2015

(54) SERVICE PROVIDING APPARATUS AND SERVICE PROVIDING METHOD

(71) Applicant: YAHOO JAPAN CORPORATION, Tokyo (JP)

(72) Inventors: Toru TAKATA, Tokyo (JP); Nobuyuki AKASHI, Tokyo (JP); Akira TAJIMA, Tokyo (JP); Koji TSUKAMOTO, Tokyo (JP); Nari WOO, Tokyo (JP); Akihiro TANABE, Tokyo (JP); Shinichiro SEGA, Tokyo (JP)

(21) Appl. No.: 14/333,103

(22) Filed: Jul. 16, 2014

(30) Foreign Application Priority Data
Sep. 19, 2013 (JP) 2013-194683

(51) Int. Cl. G06Q 30/02

(52) U.S. Cl. CPC G06Q 30/0273
USPC 705/14.69

(57) ABSTRACT

A service providing apparatus includes a request receiving unit and a service providing unit. The request receiving unit receives, from an advertiser having the right to display an advertisement on content, a resale request to resell a right to be resold to other advertisers. When the resale request is received by the request receiving unit, the service providing unit provides a resale service for reselling the right to be resold.

### CROSS-REFERENCE TO RELATED APPLICATIONS

The present application claims priority to and incorporates by reference the entire contents of Japanese Patent Application No. 2013-194683 filed in Japan on Sep. 19, 2013.

### BACKGROUND OF THE INVENTION

1. Field of the Invention

The present invention relates to a service providing apparatus and a service providing method.

2. Description of the Related Art

A distribution service has been known which distributes various kinds of content to a terminal apparatus of the user through the Internet. As an example of the distribution service, a moving image distribution service has been known which distributes moving image content and advertising content which is displayed in a display area of the moving image content.

In regard to the moving image distribution service, a technique called a program auction has been proposed. Specifically, in the program auction, sponsors bid for a given amount of investment money and only the sponsor who bids against the other sponsors has a broadcast right to a CM space for broadcasting hours. This program auction is used to make a definite promise to ensure funds beforehand.

However, in the related art, it is not always possible to provide value-added services for advertisers. Specifically, in the known art described above, advertisers simply compete for the broadcast rights for the CM space in the auction. For this reason, it is difficult to provide value-added services for both an advertiser who has acquired the broadcasting rights for the CM space and an advertiser who has not acquired the broadcasting rights for the CM space.

### SUMMARY OF THE INVENTION

It is an object of the present invention to at least partially solve the problems in the conventional technology.

According to one aspect of an embodiment, a service providing apparatus includes a request receiving unit configured to receive, from an advertiser having a right to display an advertisement on content, a resale request to resell a right to be resold to other advertiser; and a providing unit configured to provide a resale service for reselling the right to be resold when the resale request is received by the request receiving unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of the service providing process according to an embodiment;

FIG. 2 is a diagram illustrating an example of the structure of a service providing system according to the embodiment;

FIG. 3 is a diagram illustrating an example of the structure of a service providing apparatus according to the embodiment;

FIG. 4 is a diagram illustrating an example of an auction storage unit according to the embodiment;

FIG. 5 is a diagram illustrating an example of the auction storage unit according to the embodiment;

FIG. 6 is a diagram illustrating an example of the auction page according to the embodiment;

FIG. 7 is a diagram illustrating an example of the auction page according to the embodiment;

FIG. 8 is a sequence diagram illustrating the service providing procedure of the service providing system according to the embodiment;

FIG. 9 is a diagram illustrating an example of an auction storage unit according to a modification;

FIG. 10 is a diagram illustrating an example of the auction page according to the modification;

FIG. 11 is a diagram illustrating an example of the auction storage unit according to the modification;

FIG. 12 is a diagram illustrating an example of the auction page generated by a service providing unit according to the modification;

FIG. 13 is a diagram illustrating an example of the auction storage unit according to the modification;

FIG. 14 is a diagram illustrating an example of the auction page according to the modification;

FIG. 15 is a diagram illustrating an example of the service providing process according to the modification;

FIG. 16 is a diagram illustrating an example of the auction storage unit according to the modification;

FIG. 17 is a diagram illustrating an example of the service providing process according to the modification;

FIG. 18 is a diagram illustrating an example of the service providing process according to the modification;

FIG. 19 is a diagram illustrating an example of the service providing process according to the modification;

FIG. 20 is a diagram illustrating an example of the structure of a service providing apparatus according to the modification;

FIG. 21 is a diagram illustrating an example of a history information storage unit according to the modification;

FIG. 22 is a diagram illustrating an example of the content according to the modification; and

FIG. 23 is a hardware block diagram illustrating an example of a computer to realize the function of the service providing apparatus.

### DETAILED DESCRIPTION OF THE PREFERRED EMBODIMENTS

Hereinafter, a service providing apparatus, a service providing method, and a service providing program according to exemplary embodiment (hereinafter, referred to as an “embodiment”) will be described in detail with reference to the accompanying drawings. In addition, the service providing apparatus, the service providing method, and the service providing program are not limited by the embodiment. In the following embodiments, the same components are denoted by the same reference numerals and the description thereof will not be repeated.

1. Service Providing Process

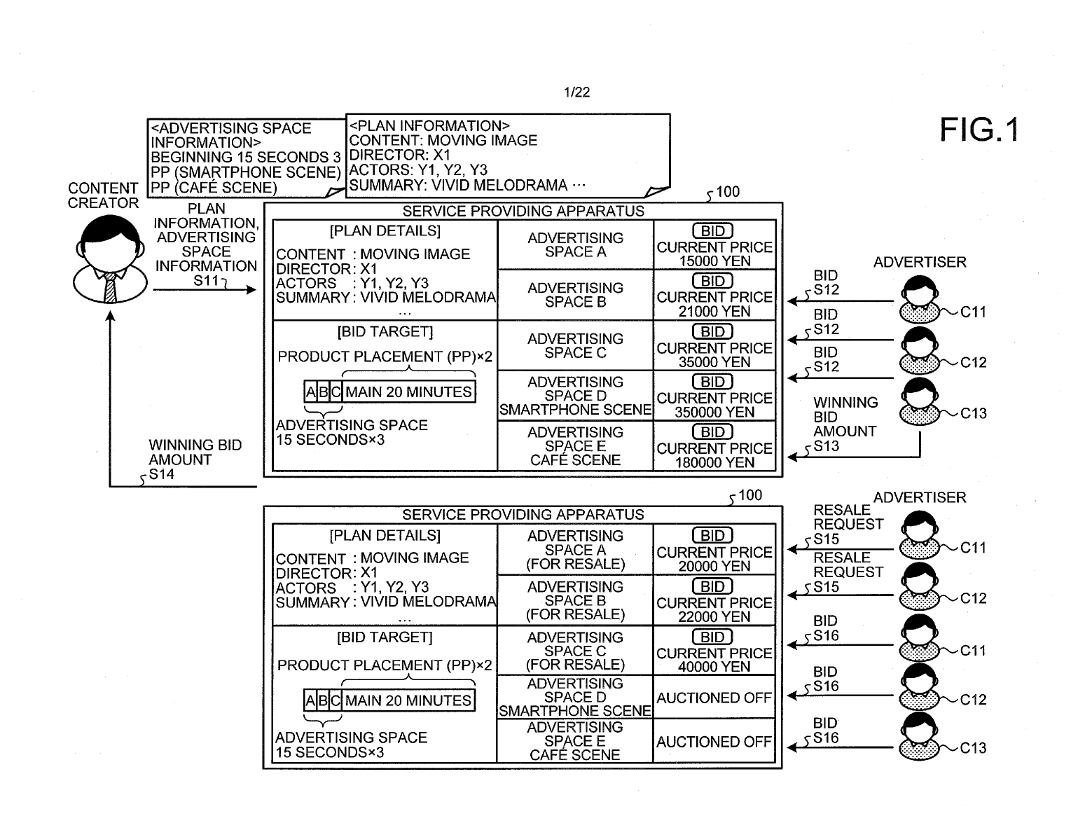

First, an example of the service providing process according to an embodiment will be described with reference to FIG. 1. FIG. 1 is a diagram illustrating an example of the service providing process according to the embodiment. A service providing apparatus 100 illustrated in FIG. 1 provides the resale service for reselling the right to display an advertisement on the content (hereinafter, may be written as an “advertising right”) to other advertisers. Hereinafter, an example is illustrated in which the service providing apparatus 100 provides the resale service for reselling the advertising right in an auction format. Hereinafter, a moving image is given as an example of content.

As illustrated in the upper part of FIG. 1, the service providing apparatus 100 receives plan information indicating a plan of a moving image and advertising space information relating to an advertising space which is set to the moving image by the content creator, from the content creator who plans to create the moving image (Step S11). In the following description, in some cases, the plan of content (for example, the moving image) is referred to as a “content-plan”. In addition, the service providing apparatus 100 may receive the plan information and the advertising space information at the same time or at different times.

In the example illustrated in FIG. 1, the plan information transmitted by the content creator includes information indicating that the type of content is a moving image, the director of the moving image is “X1”, the actors of the moving image are “Y1”, “Y2”, and “Y3”, and the summary of the moving image is “vivid melodrama”. In addition, the advertising space information transmitted by the content creator includes information relating to three advertising spaces which are set to the beginning of the moving image, an advertising space which is set to a scene in which a smart phone is used among various kinds of scenes included in the moving image, and an advertising space which is set to a café scene. Here, the advertising space set to the scene in which a smart phone is used or the advertising space set to the scene of the café indicates a cast frame to make a product that an advertiser desires to advertise appear in the moving image. For example, an advertiser who has made a successful bid for the advertising space, which is set for the scene in which a smart phone is used, can make cast members appearing in the moving image use the smart phone to be advertised. Such a method of displaying an advertisement in the main part of the moving image so as to be associated with a specific scene or a cast member is called product placement or the like.

Subsequently, the service providing apparatus 100 presents the plan information received from the content creator to advertisers and provides a sales service for selling the advertising right, which are the right to display an advertisement in the advertising space set to the moving image, to the advertiser. Specifically, as the sales service, the service providing apparatus 100 according to the embodiment provides an auction service in which a bid target, that is an item to be auctioned off, is the advertising right. That is, the service providing apparatus 100 holds an auction in which the bid target is the right to incorporate an advertisement into a moving image in the stage in which the content creator plans to create the moving image.

In the example illustrated in FIG. 1, the service providing apparatus 100 opens the type, director, actors, and summary of the content on the basis of the plan information and provides the auction service related to each advertising space on the basis of the advertising space information. Specifically, the service providing apparatus 100 individually holds auctions for the advertising spaces A, B, and C displayed in the beginning of the moving image and the advertising spaces D and E displayed in the main story of the moving image.

Then, the service providing apparatus 100 receives bids from the advertisers in each auction (step S12). Then, the service providing apparatus 100 determines the advertiser who bids the highest price to be a winning bidder for the period for which the auction is being held and receives the winning bid amount from the winning bidder (step S13). Then, the service providing apparatus 100 sends the winning bid amount received from the winning bidder to the content creator (step S14). Although subsequent processes will be described in detail later, the service providing apparatus 100 generates a moving image to be distributed by incorporating advertisement data received from the winning bidder into the moving image created by the content creator after all auctions for respective advertising spaces are successful. In addition, although the advertisement of a different advertiser is displayed on a general web page for each access to the web page, only advertisement data corresponding to the winning bidder is incorporated into each advertising space set for the content such as a moving image according to the embodiment. That is, an advertiser who has become the winning bidder will monopolize the advertising space in which an advertisement is displayed.

Then, in the example illustrated in the upper part of FIG. 1, an advertiser C11 makes a successful bid for the advertising spaces A and B, an advertiser C12 makes a successful bid for the advertising space C, and an advertiser C13 makes a successful bid for the advertising spaces D and E. Then, the service providing apparatus 100 according to the embodiment provides a resale service for reselling the advertising right to be resold.

For example, in the example illustrated in the lower part of FIG. 1, it is assumed that the service providing apparatus 100 receives a request to resell the advertising spaces A and B from the advertiser C11 and receives a request to resell the advertising space C from the advertiser C12 (step S15). In other words, the service providing apparatus 100 receives a request to resell the right to display an advertisement in the advertising space A from the advertiser C11 who monopolizes the right to display an advertisement in the advertising space A. In addition, the service providing apparatus 100 receives a request to resell the right to display an advertisement in the advertising space B from the advertiser C11 who monopolizes the right to display an advertisement in the advertising space B. In addition, the service providing apparatus 100 receives a request to resell the right to display an advertisement in the advertising space C from the advertiser C12 who monopolizes the right to display an advertisement in the advertising space C. In this case, the service providing apparatus 100 provides, as the resale service, an auction service in which a bid target is the advertising right in the advertising spaces A, B, and C (step S16).

Then, similarly to the example illustrated in the upper part of FIG. 1, the service providing apparatus 100 receives the winning bid amount from a winning bidder when the winning bidder is determined. Then, the service providing apparatus 100 sends the advertiser of the resale source the winning bid amount received from the winning bidder. For example, it is assumed that the advertiser C12 has made a successful bid for the advertising space A illustrated in the above example. In this case, the service providing apparatus 100 transfers the winning bid amount received from the advertiser C12 to the advertiser C11 who has resold the advertising space A.

Then, when the resale of the advertising right is successful, the service providing apparatus 100 generates a new moving image to be distributed by replacing the advertisement data incorporated into the moving image created by the content creator. Specifically, the service providing apparatus 100 replaces the advertisement data corresponding to the advertiser of the resale source with advertisement data corresponding to the advertiser of the resale destination which is purchaser of the right to be resold. As a result, a moving image in which advertisement data submitted by each advertiser, who has become a new winning bidder in the lower part of FIG. 1, is incorporated into each advertising space is distributed to users (moving image viewers).

Thus, as in the example illustrated in the upper part of FIG. 1, the service providing apparatus 100 according to the embodiment provides an auction service for the advertising right in a stage where the content creator plans to create a moving image and an auction service for the advertising right auctioned off once.

Then, when an auction is held in the stage where the content creator plans to create a moving image, the service providing apparatus 100 sends the winning bid amount of the auction to the content creator. In this manner, the service providing apparatus 100 can raise funds for the content creator who plans to create content. That is, since the service providing apparatus 100 can raise funds for the content creator who runs short of funds, for example, it is possible to support to create the content.

In addition, the service providing apparatus 100 can provide value-added services for advertisers by holding an auction for reselling the advertising right. For example, depending on the advertiser who has made a successful bid for the advertising right in the example illustrated in the upper part of FIG. 1, the advertising right may not be required since the advertising period of the product has expired. In addition, depending on the advertiser who has not made a successful bid for the advertising right in the example illustrated in the upper part of FIG. 1, it may be possible to invest a large amount of advertising expenses since a lot of advertising budget could be secured after the auction was successful. The service providing apparatus 100 according to the embodiment can meet the demands of these advertisers by providing the resale service. Therefore, value-added services can be provided for both an advertiser who has acquired the advertising right and an advertiser who has not acquired the advertising right.

2. Structure of Service Providing System

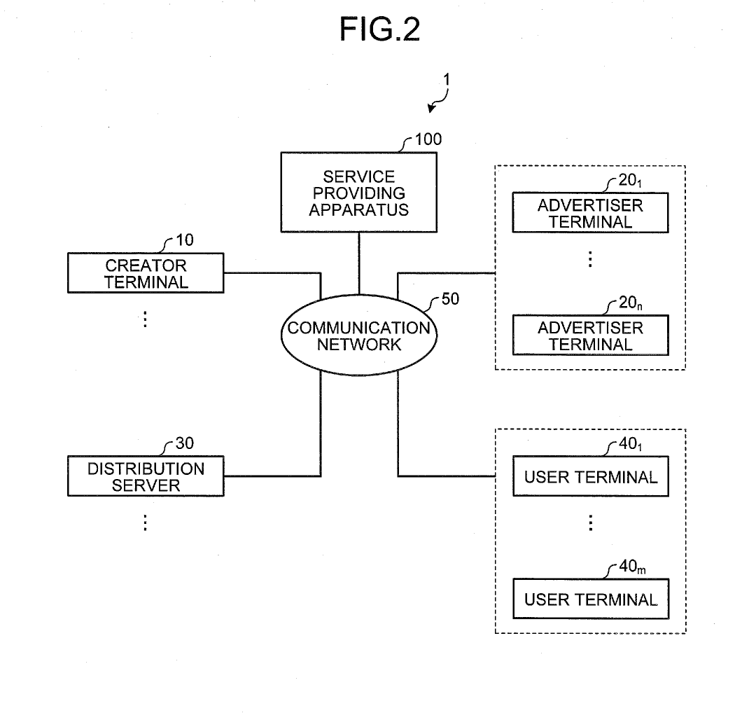

Next, the structure of the service providing system according to the embodiment will be described with reference to FIG. 2. FIG. 2 is a diagram illustrating an example of the structure of the service providing system according to the embodiment. As illustrated in FIG. 2, a service providing system 1 includes a creator terminal 10, advertiser terminals 20₁ to 20ₙ, a distribution server 30, user terminals 40₁ to 40ₘ, and the service providing apparatus 100. The creator terminal 10, the advertiser terminals 20₁ to 20ₙ, the distribution server 30, the user terminals 40₁ to 40ₘ, and the service providing apparatus 100 are connected through a communication network 50 so as to communicate with each other wirelessly or by wire. In addition, the service providing system 1 illustrated in FIG. 2 may include a plurality of creator terminals 10, a plurality of distribution servers 30, a plurality of service providing apparatuses 100.

The creator terminal 10 is an information processing apparatus which is used by the content creator. For example, the creator terminal 10 is operated by the content creator to transmit the plan information, the advertising space information, or content, such as a moving image created by the content creator, to the service providing apparatus 100. In the following description, in some cases, the creator terminal 10 is referred to as a content creator. That is, in the following description, the content creator may be replaced with the creator terminal 10.

In some cases, the content creator requests an agent to transmit the plan information. In this case, the agent uses the auction service provided by the service providing apparatus 100. Hereinafter, it is assumed that the term “content creator” includes the agent in addition to the content creator and the term “creator terminal” includes an agent terminal used by the agent in addition to the advertiser terminal.

The advertiser terminals 20₁ to 20ₙ are information processing apparatuses used by advertisers. For example, the advertiser terminals 20₁ to 20ₙ are operated by the advertisers to acquire a web page (hereinafter, may be written as an “auction page”) related to the auction service from the service providing apparatus 100 or to transmit bid information or advertisement data to the service providing apparatus 100. In the following description, in some cases, when it is not necessary to distinguish the advertiser terminals 20₁ to 20ₙ, the advertiser terminals 20₁ to 20ₙ are generically referred to as an “advertiser terminal 20”. In addition, in the following description, in some cases, the advertiser terminal 20 is referred to as an advertiser, a bidder, or a winning bidder. That is, in the following description, the advertiser, the bidder, or the winning bidder may be replaced with the advertiser terminal 20.

In some cases, the advertiser requests the agent to perform a bid operation. In this case, the agent uses the auction service provided by the service providing apparatus 100. In the following description, it is assumed that the term “advertiser” includes the agent in addition to the advertiser and the term “advertiser terminal” includes the agent terminal used by the agent in addition to the advertiser terminal.

The distribution server 30 is, for example, a web server or the like. The distribution server 30 receives distribution target content from the service providing apparatus 100. In addition, the distribution server 30 distributes the content received from the service providing apparatus 100 in response to the requests from the user terminals 40₁ to 40ₘ.

The user terminals 40₁ to 40ₘ are information processing apparatuses used by users who browse content. For example, the user terminals 40₁ to 40ₘ are operated by the users to acquire content, such as a moving image, from the distribution server 30 and to display the acquired content on a display device (for example, liquid crystal display). In the following description, when it is not necessary to distinguish the user terminals 40₁ to 40ₘ, the user terminals 40₁ to 40ₘ are generically referred to as a “user terminal 40”. In the following description, in some cases, the user terminal 40 is referred to as a user or a viewer. That is, in the following description, the user or the viewer may be replaced with the user terminal 40.

The service providing apparatus 100 is, for example, a web server or the like. As described with reference to FIG. 1, the service providing apparatus 100 provides the auction service related to the advertising space which is incorporated into content in the planning stage, or the resale service for reselling the advertising right.

The creator terminal 10, the advertiser terminal 20, or the user terminal 40 is implemented by, for example, a desktop personal computer (PC), a notebook PC, a tablet terminal, a mobile phone, or a personal digital assistant (PDA).

3. Structure of the Service Providing Apparatus

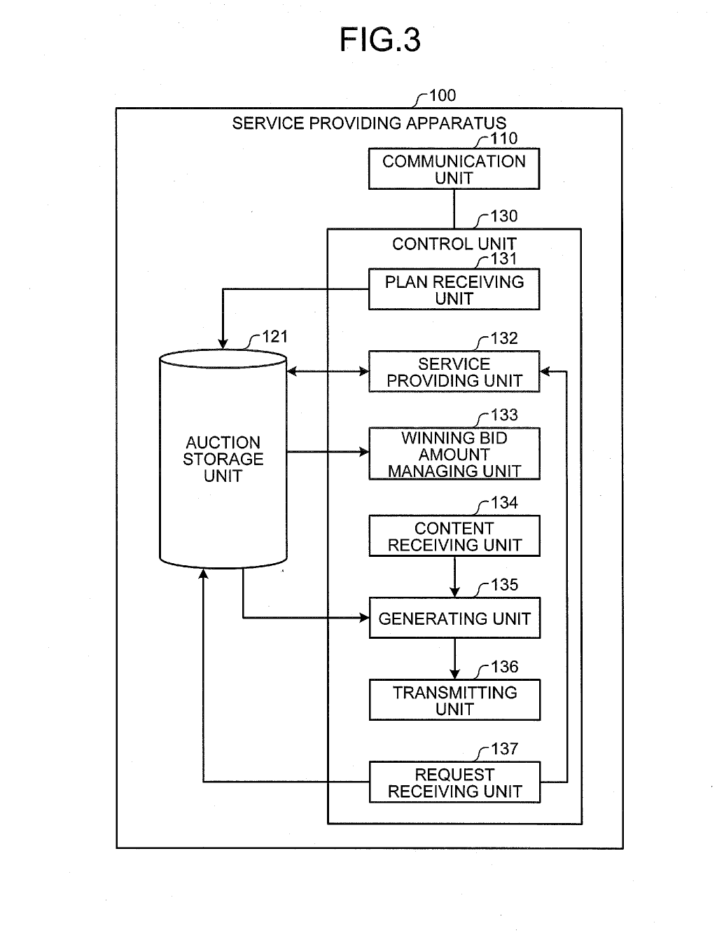

Next, the structure of the service providing apparatus 100 according to the embodiment will be described with reference to FIG. 3. FIG. 3 is a diagram illustrating an example of the structure of the service providing apparatus 100 according to the embodiment. As illustrated in FIG. 3, the service providing apparatus 100 includes a communication unit 110, an auction storage unit 121, and a control unit 130. In addition, the service providing apparatus 100 may include an input unit (for example, a keyboard or a mouse) which receives various types of operations from the administrator or the like of the service providing apparatus 100 or a display unit (for example, a liquid crystal display) which displays various kinds of information.

The communication unit 110 is implemented by, for example, a network interface card (NIC). The communication unit 110 is connected to the communication network 50 by wire or wirelessly. In addition, the communication unit 110 transmits and receives information to and from the creator terminal 10, the advertiser terminal 20, or the distribution server 30 through the communication network 50.

The auction storage unit 121 is implemented by a semiconductor memory element, such as a random access memory (RAM) or a flash memory, or a storage device, such as a hard disk or an optical disk, for example. The auction storage unit 121 according to the embodiment stores various kinds of information regarding an auction.

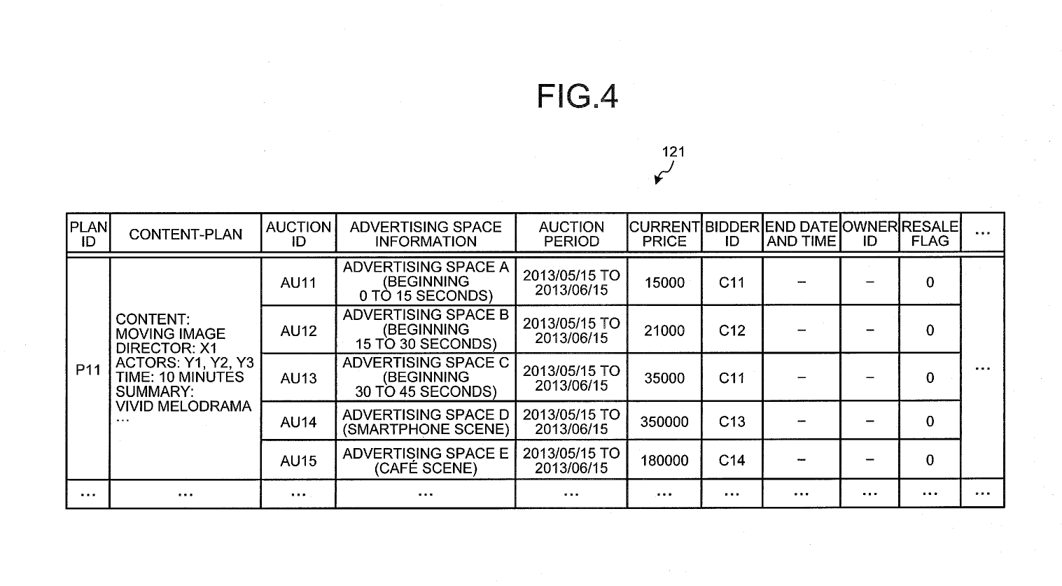

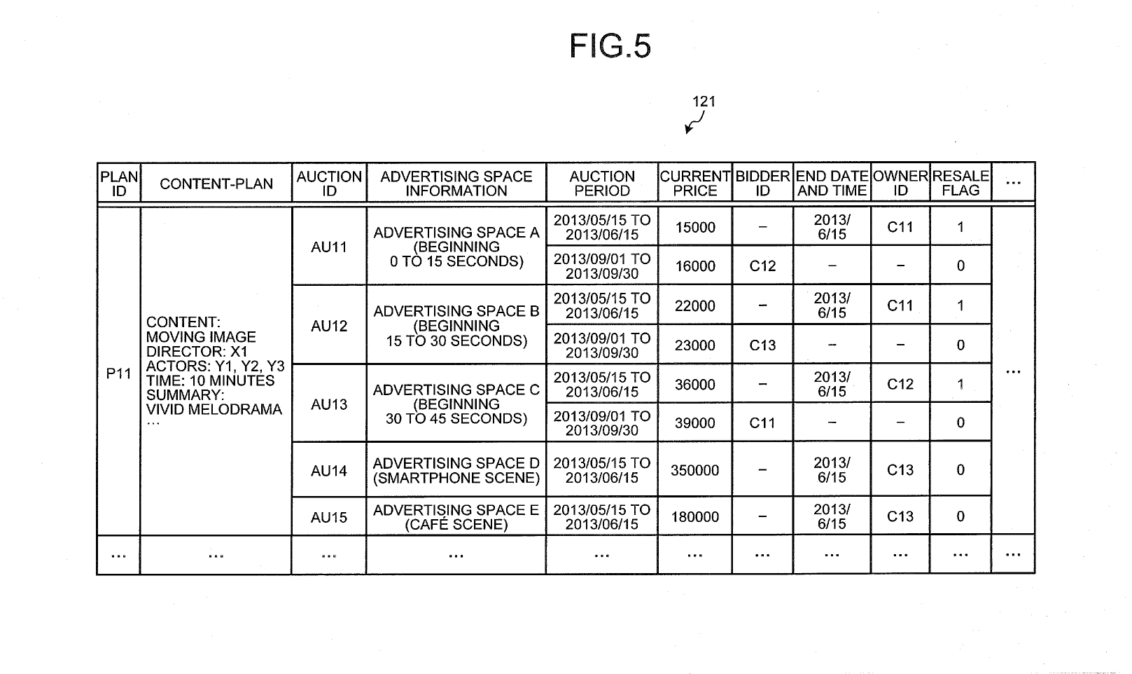

FIGS. 4 and 5 illustrate an example of the auction storage unit 121 according to the embodiment. In addition, FIG. 4 illustrates an example (for example, the state in the upper part of FIG. 1) before receiving the resale request, and FIG. 5 illustrates an (for example, the state in the lower part of FIG. 1) after receiving the resale request. As illustrated in FIGS. 4 and 5, the auction storage unit 121 has items, such as “plan ID”, “content-plan”, “auction ID”, “advertising space information”, “auction period”, “current price”, “bidder ID”, “end date and time”, “owner ID”, and “resale flag”.

The “plan ID” indicates identification information for identifying content which is planned to be created by the content creator. The “content-plan” indicates, for example, skeleton, details or the like of the content. The “auction ID” indicates identification information for identifying the auction related to each advertising space. In other words, the “auction ID” indicates identification information for identifying an advertising space. The “advertising space information” indicates information related to the advertising space incorporated into the content. The “auction period” indicates the period for which the auction is held. The “current price” indicates the highest price of bid prices offered for the auction at the moment. The “bidder ID” indicates an advertiser ID for identifying the advertiser who is a bidder who has bid a highest price at the moment. The “end date and time” indicates date and time when the auction has ended.

The “owner ID” indicates an advertiser ID for identifying the winning bidder who is an advertiser having the advertising right. The “resale flag” indicates a resale status of the advertising right. In FIGS. 4 and 5, it is assumed that “1 (resale)” is stored in the “resale flag” when the advertising right has been resold or when the advertising right is for resale and “0 (non-resale)” is stored in the “resale flag” when the advertising right has not been resold.

In addition, in FIGS. 4 and 5, an auction for which the date and time is not stored in the “end date and time” indicates an auction that is being held or has not been held, and an auction for which the date and time is stored in the “end date and time” indicates an auction that has ended. In addition, when the date and time is stored in the “end date and time”, the current price corresponds to the winning bid price. In addition, in the example of FIGS. 4 and 5, it is assumed that the “bidder ID” and the “owner ID” correspond to reference numerals given to the advertisers illustrated in FIG. 1. For example, the bidder ID “C11” or the owner ID “C11” indicates the advertiser C11.

Here, the states illustrated in FIGS. 4 and 5 will be described. For example, FIG. 4 illustrates an example where the content identified by the plan ID “P11” is being planned by the content creator and the content-plan is a moving image or the like. In addition, FIG. 4 illustrates an example where five advertising spaces A to E are included in the content. In addition, FIG. 4 illustrates an example where an auction for the advertising space A is identified by the auction ID “AU11” and similarly, auctions for the advertising spaces B to E are identified by the auction IDs “AU12”, “AU13”, “AU14”, and “AU15”, respectively. In addition, FIG. 4 illustrates an example where the auctions for the advertising spaces A to E are being held or have not been held. Thus, the auction storage unit 121 stores the auction ID corresponding to each advertising space, which is included in the content, so as to match one plan ID (that is, the content in the planning stage).

In addition, the first record in FIG. 5 illustrates an example where the advertiser C11 has made a successful bid for the right to display an advertisement in the advertising space A. In addition, FIG. 5 illustrates an example where a resale request indicating that the advertising right in the advertising space A is for resale has been transmitted from the advertiser C11. In this case, as illustrated in the first record in FIG. 5, “1 (resale)” is stored in the resale flag. In addition, as illustrated in the second record in FIG. 5, a new record is added to the auction storage unit 121 so as to match the auction ID “AU11”. Specifically, the second record in FIG. 5 illustrates an example where an auction for the advertising space A for resale is being held. Then, when the auction for the advertising space A for resale is successful, an advertiser ID of the advertiser who is a winning bidder is stored in the owner ID corresponding to the second record in FIG. 5. In addition, although detailed explanation is omitted herein, FIG. 5 illustrates an example where a request to resell the advertising right in the advertising space B has been transmitted from the advertiser C11 and a request to resell the advertising right in the advertising space C has been transmitted from the advertiser C12. On the other hand, FIG. 5 illustrates an example where a request to resell the advertising right in the advertising spaces D and E has not been transmitted from the advertiser C13.

Thus, in the case of FIG. 5, the owner ID corresponding to the resale flag “1 (resale)” indicates an advertiser who has resold the advertising right. On the other hand, the owner ID corresponding to the resale flag “0 (resale)” indicates an advertiser whose advertisement is incorporated into the content. That is, the auction storage unit 121 illustrated in FIG. 5 also stores history information regarding the resale of the advertising right.

In addition, the information stored in the auction storage unit 121 is not limited to the example of FIGS. 4 and 5. For example, the auction storage unit 121 may store information, such as a “creator ID” for identifying the content creator. In addition, for example, the auction storage unit 121 may store “prompt decision price”, which indicates a price at which it is possible to immediately make a successful bid for the advertising right, or “minimum bid price”, which indicates a minimum price for a successful bid for the advertising right, for each auction ID. For example, the “prompt decision price” and the “minimum bid price” are included in the advertising space information transmitted from the creator terminal 10 to the service providing apparatus 100, and are set by the content creator.

In addition, the auction storage unit 121 may not store the resale history information. That is, the auction storage unit 121 may store only the latest state for each auction ID.

In addition, in FIG. 5, an example where auctions for the same advertising space are identified by the same auction ID is illustrated. However, an auction for the advertising right may be identified by a new auction ID whenever the advertising right in the advertising space is resold. For example, the first and second records in FIG. 5 may be different auction IDs. In this case, the auction storage unit 121 stores information for associating both records with each other (for example, an advertising space ID for identifying the advertising space).

Referring back to FIG. 3, the control unit 130 is realized, for example, when a central processing unit (CPU) or a micro processing unit (MPU) executes various programs (equivalent to an example of a service providing program), which is stored in a storage device of the service providing apparatus 100, with the RAM as a work area. In addition, the control unit 130 is realized by an integrated circuit, such as an application specific integrated circuit (ASIC) or a field programmable gate array (FPGA), for example.

As illustrated in FIG. 3, the control unit 130 includes a plan receiving unit 131, a service providing unit 132, a winning bid amount managing unit 133, a content receiving unit 134, a generating unit 135, a transmitting unit 136, and a request receiving unit 137, and performs or implements the following information processing function or operation. In addition, the internal structure of the control unit 130 is not limited to that illustrated in FIG. 3, but the control unit 130 may have any structure as long as it can perform the following information processing. In addition, the connection relation between the processing units of the control unit 130 is not limited to that illustrated in FIG. 3, but other connection relations may be established between the processing units.

The plan receiving unit 131 receives the plan information and the advertising space information from the content creator (for example, the creator terminal 10) who plans to create content. Specifically, the plan receiving unit 131 receives, from the content creator, the plan information indicating the content-plan, and the advertising space information relating to the advertising space which is set to the content by the content creator. Then, when the plan information and the advertising space information are received, the plan receiving unit 131 assigns a new plan ID and also assigns an auction ID for each advertising space set to the content. Then, the plan receiving unit 131 stores the plan information in the “content-plan” of the auction storage unit 121 so as to be associated with the new plan ID. In addition, the plan receiving unit 131 stores the auction ID for each advertising space in the auction storage unit 121 so as to be associated with the plan ID and stores the advertising space information in the “advertising space information” of the auction storage unit 121 so as to be associated with each auction ID. In this case, the plan receiving unit 131 may also store a creator ID corresponding to the content creator, who is a transmission source of the plan information and the advertising space information, in the auction storage unit 121. For example, the creator ID is transmitted together with the plan information and the advertising space information by the content creator. Alternatively, when login is required to use various services provided by the service providing apparatus 100, the login ID or the like of the content creator may be the creator ID.

In addition, the plan receiving unit 131 analyzes, for example, the plan information to extract information corresponding to each item, such as the type, director, and actors of the content. For example, when the plan information is described by a markup language, such as XML (Extensible Markup Language), the plan receiving unit 131 can easily extract the information corresponding to each item from the plan information. In addition, when the format of the plan information is determined in advance, the plan receiving unit 131 can easily extract various kinds of information from the plan information based on the format determined in advance. Similarly, when the advertising space information is described by a markup language or when the format of the advertising space information is determined in advance, the plan receiving unit 131 can easily extract various kinds of information from the advertising space information.

In addition, the plan receiving unit 131 may receive advertising space information including the auction period set by the content creator. In this case, the plan receiving unit 131 stores the auction period, which is included in the advertising space information, in the auction storage unit 121. However, the plan receiving unit 131 may store the auction period, which is determined in advance, in the auction storage unit 121 without being limited to this example. For example, the plan receiving unit 131 may set, as the auction period, a period until predetermined days pass from the date and time when the advertising space information is received.

In addition, the plan receiving unit 131 may provide content creators with a submission site for inputting the plan information or the advertising space information. For example, the plan receiving unit 131 provides a submission site for inputting the type, content-plan, or the like of the content. In addition, for example, the plan receiving unit 131 provides a submission site for inputting the temporal position where an advertising space is reproduced (hereinafter, may be written as a reproduction position), reproduction time of the advertising space, display size of the advertising space, or the like. In this case, the plan receiving unit 131 receives various kinds of information input to the submission site as plan information and advertising space information.

Subsequently, each processing unit, such as the service providing unit 132, will be described. Hereinafter, each processing unit, such as the service providing unit 132, will be described for a state before the resale request is received (for example, the state in the upper part of FIG. 1) and a state after the resale request is received (for example, the state in the lower part of FIG. 1).

First, each processing unit before receiving the resale request will be described. The service providing unit 132 presents the plan information received by the plan receiving unit 131, and provides the auction service in which the bid target is the right (that is, advertising right) to display an advertisement in the advertising space that is set to content by the content creator.

Specifically, when a request for an auction page is received from the advertiser terminal 20, the service providing unit 132 provides the auction page to the advertiser terminal 20. In this case, the service providing unit 132 provides an auction page including the content-plan and information about the auction related to each advertising space, on the basis of the plan information and the advertising space information received from the content creator.

As an example, the service providing unit 132 transmits a list of the content-plan stored in the auction storage unit 121 to the advertiser terminal 20. Then, the service providing unit 132 receives an acquisition request including a plan ID which corresponds to the content-plan selected from the list, from the advertiser terminal 20. In this case, the service providing unit 132 acquires various kinds of information corresponding to the plan ID, which is included in the acquisition request, from the auction storage unit 121. In the example of FIG. 4, the service providing unit 132 acquires, from the auction storage unit 121, the content-plan and the auction period corresponding to the plan ID, and the advertising space information, the current price, the bidder ID, the end date and time, and the like for each auction ID corresponding to the plan ID. Then, the service providing unit 132 generates an auction page, on which content-plan and the like are published, using the acquired various kinds of information, and provides the generated auction page to the advertiser terminal 20.

In addition, the service providing unit 132 receives bid information including the bid price from the advertiser terminal 20 through the auction page. In this case, the service providing unit 132 stores the bid price included in the bid information in the auction storage unit 121 so as to be associated with the auction ID indicating the auction for which a bid is to be made. In this case, the service providing unit 132 also stores the bidder ID corresponding to the bidder, who is the transmission source of the bid information, in the auction storage unit 121. In addition, the service providing unit 132 may receive the bidder ID together with the bid information, or may consider the login ID or the like of the bidder as a bidder ID. In addition, when an auction is successful, the service providing unit 132 stores the end date and time of the auction in the end date and time of the auction storage unit 121, and stores an advertiser ID for identifying the winning bidder in the owner ID of the auction storage unit 121.

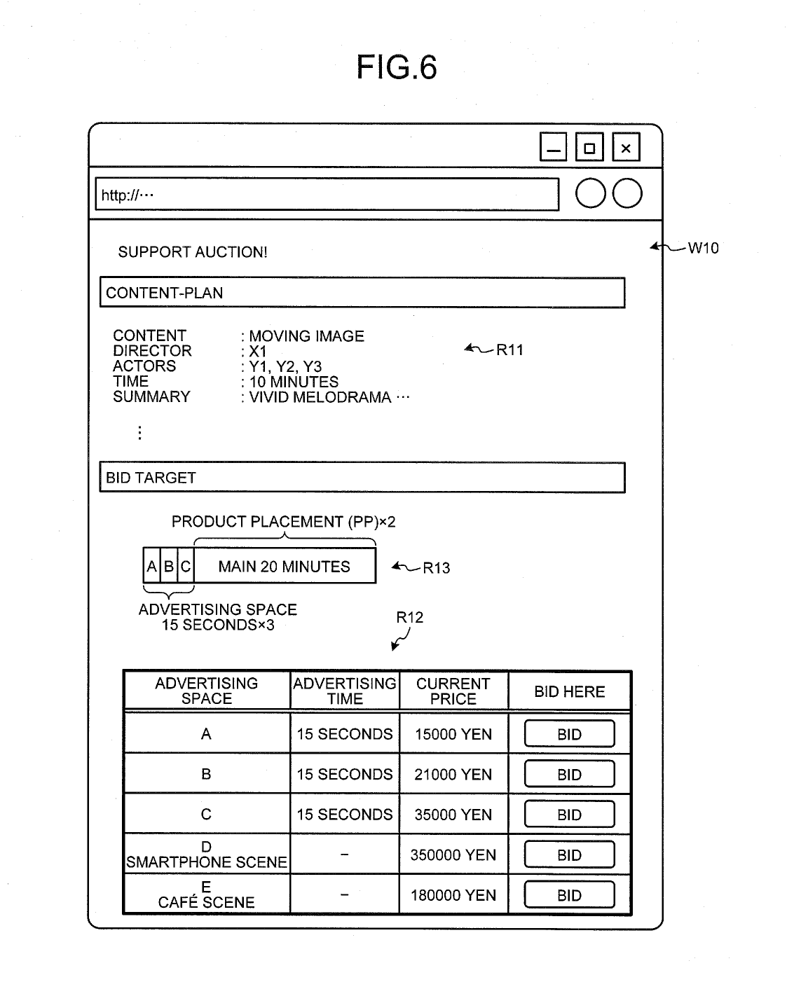

Here, FIG. 6 illustrates an example of the auction page generated by the service providing unit 132 according to the embodiment. FIG. 6 illustrates an example of an auction page W10 corresponding to the plan ID “P11” illustrated in FIG. 4. As in the example illustrated in FIG. 6, the service providing unit 132 inserts the content-plan stored in the auction storage unit 121 into a plan display field R11 of the auction page W10. In addition, the service providing unit 132 inserts, for example, the advertising space information and the like for each auction ID, which are stored in the auction storage unit 121 so as to be associated with the plan ID “P11” into a bid display field R12 of the auction page W10. In addition, the service providing unit 132 inserts an image diagram in which the reproduction position of the advertising space is visible into an image display field R13 of the auction page W10. Thus, when the advertising space information includes information regarding a plurality of advertising spaces, the service providing unit 132 inserts all pieces of the advertising space information into the auction page W10 and individually holds the auctions related to each advertising space.

In addition, although not illustrated in the drawings, when a bid button displayed in the bid display field R12 is pressed, the service providing unit 132 provides a bid page for inputting the bid price to the advertiser terminal 20. Then, the service providing unit 132 receives bid information including the bid price from the advertiser terminal 20 through the bid page.

In addition, the service providing unit 132 assumes that, when all auctions for respective advertising spaces have ended, all of the auctions are successful formally. Specifically, the service providing unit 132 assumes that, even if some of auctions for respective advertising spaces have ended, some of the auctions are temporarily successful until all auctions are successful. In the example illustrated in FIG. 6, the service providing unit 132 holds five auctions for advertising spaces A to E. Here, when the holding period of each auction is different or when a buyout price is set for each auction, the five auctions do not necessarily end simultaneously. For example, it is assumed that only the auction for the advertising space A among the five auctions has ended. In this case, the service providing unit 132 assumes that the auction for the advertising space is temporarily successful and the winning bidder is temporarily determined until all of the five auctions are successful. Then, the service providing unit 132 assumes that all auctions have been successful formally after the end of all of the five auctions, and determines a winning bidder of each auction. That is, although the service providing unit 132 stores the end date and time in the auction storage unit 121 whenever the winning bidder is determined and the auction ends, the service providing unit 132 assumes that all auctions have been successful formally when the end date and time corresponding to all of a plurality of auction IDs corresponding to one plan ID is stored.

Here, the service providing unit 132 may assume that no auctions have been successful when some of the plurality of auctions are not successful. As a state where an auction is not successful, a case where there is no bid, a case where the highest bid price does not reach the minimum bid price, and the like can be mentioned. In this case, the service providing unit 132 may hold all auctions again. Alternatively, the service providing unit 132 may hold again only some auctions that have not been successful. In this case, the service providing unit 132 may set a minimum bid price, which is lower than the last minimum bid price, for the auction to be held again. Alternatively, when some of the plurality of auctions are not successful, the service providing unit 132 may notify the content creator of the situation. In addition, according to the instruction from the content creator, the service providing unit 132 may hold all auctions again, or may determine whether to hold again only some auctions that have not been successful.

In addition, the auction page W10 is not limited to that illustrated in FIG. 6. For example, the service providing unit 132 may insert the name or the like of the content creator into the plan display field R11. In addition, for example, the service providing unit 132 may display information (for example, a company name or the type of industry) regarding a bidder who has bid the highest price. In addition, for example, the content creator may set the target price of the reserve price as an estimated price required to create content to the plan information. In this case, the service providing unit 132 may insert the target price of the winning bid price into the plan display field R11. In addition, for example, the service providing unit 132 may insert the holding period of the auction in the bid display field R12. In addition, for example, the service providing unit 132 may not insert the image diagram into the image display field R13.

The winning bid amount managing unit 133 manages the winning bid amount received from the winning bidder who has successfully bid the advertising right. Specifically, even when winning bid amount is received from the winning bidder, the winning bid amount managing unit 133 instantly stores the entire winning bid amount, without sending the winning bid amount to the content creator. Whenever the content creator charges for the creation of content, the winning bid amount managing unit 133 sends the amount of money corresponding to the charge from the stored reserve price to the content creator. For example, the winning bid amount managing unit 133 receives, from the creator terminal 10, charge data, such as clothing expenses, filming expenses, or food expenses which have been actually used to create content, or food expenses which will be used to create content immediately. Then, the winning bid amount managing unit 133 sends the amount of money corresponding to the received charge data to the content creator. In addition, the winning bid amount managing unit 133 manages winning bid amount using the current price (that is, the highest bid price) stored in the auction storage unit 121.

Thus, the winning bid amount managing unit 133 does not instantly send the winning bid amount received from the winning bidder to the content creator, but gradually sends the winning bid amount in response to the request from the content creator. Therefore, the winning bid amount managing unit 133 can prevent the winning bid amount from being sent to the content creator who does not create content. As a result, the winning bid amount managing unit 133 can prevent the abuse of the auction service provided by the service providing apparatus 100.

In addition, when the total amount of money charged by the content creator is less than the winning bid amount, the winning bid amount managed by the winning bid amount managing unit 133 is left over. In this case, the winning bid amount managing unit 133 may send the surplus money to the content creator after the content creator has created the content. Accordingly, since the winning bid amount managing unit 133 pays the content creator compensation for the completion of the content, it is possible to improve the creative impulse of the content creator.

In addition, although the example where the winning bid amount managing unit 133 transfers winning bid amount to the content creator is illustrated in the example described above, the winning bid amount managing unit 133 may perform only processing for calculating the amount of money transferred to the content creator. Then, the administrator or the like of the service providing apparatus 100 may transfer to the content creator the amount of money calculated by the winning bid amount managing unit 133.

The content receiving unit 134 receives the content corresponding to the plan information from the content creator (for example, the creator terminal 10). For example, when the content creator which has transmitted the plan information completes content, the content receiving unit 134 receives a completed content. In addition, the content receiving unit 134 receives advertisement data which is incorporated into the advertising space from the winning bidder (for example, the advertiser terminal 20) who has successful bid for the advertising right.

In addition, the winning bidder having the advertising right may transfer the advertising right to other advertisers. In this case, the content receiving unit 134 receives the advertisement data not only from a winning bidder but from the advertiser having the advertising right. Hereinafter, it is assumed that the term ‘winning bidder’ includes the advertiser to which the advertising right has been transferred.

The generating unit 135 combines the content and the advertising data received from the content receiving unit 134 to generate composite content. Specifically, the generating unit 135 generates composite content after all auctions corresponding to the predetermined plan information (plan ID) are successful in the auction service provided by the service providing unit 132. In this case, the generating unit 135 generates composite content by incorporating the advertisement data of the advertiser, who has made a successful bid for the right to display an advertisement in an advertising space set to the content created by the content creator, in the advertising space based on the advertising space information stored in the auction storage unit 121.

In addition, as described above, the advertising space for which the advertiser has made a successful bid may correspond to a cast frame in which an advertising product appears in an image, as in the product placement. In this case, for example, the content creator receives an advertising product from the advertiser, who is a winning bidder, and creates the content, such as a moving image, using the received advertising product. Therefore, when the advertising space is the product placement, the content creator creates composite content including the advertisement data. That is, the content received by the content receiving unit 134 may correspond to composite content. For this reason, the generating unit 135 does not perform the process of generating the composite content when the advertising space set to the content is only the product placement. In other words, the generating unit 135 performs the above process of generating the composite content when advertising spaces that can be incorporated into the finished product of the content, such as the advertising spaces A to C illustrated in FIG. 1 and the like, are set to the content.

The transmitting unit 136 transmits the composite content generated by the generating unit 135 or the composite content received by the content receiving unit 134 to the distribution server 30. As a result, the distribution server 30 distributes the composite content, in which the advertisement data is incorporated, to the user terminal 40 in response to a request from the user terminal 40.

Subsequently, each processing unit after receiving the resale request will be described. The request receiving unit 137 receives a resale request, which is a request to resell the advertising right to other advertisers, from the advertiser (for example, the advertiser terminal 20) having the advertising right. Then, the request receiving unit 137 updates the auction storage unit 121 when the resale request is received.

The process of the request receiving unit 137 will be described with reference to FIG. 5. For example, it is assumed that the advertiser C11 has been determined as a winning bidder of an auction for the advertising space A. In this case, the service providing unit 132 stores “C11” in the owner ID, as illustrated in the first record of FIG. 5. Then, it is assumed that the request receiving unit 137 receives a resale request to resell the advertising right in the advertising space A from the advertiser C11. In this case, the request receiving unit 137 updates the resale flag to “1”, as illustrated in the first record of FIG. 5. In addition, the request receiving unit 137 adds a new record, in which the resale flag is “0”, to the auction storage unit 121, as illustrated in the second record of FIG. 5. In this manner, the request receiving unit 137 adds the information (second record of FIG. 5), which indicates that the advertising right (that is, the right to display an advertisement in the advertising space A) is for resale, while leaving the information (first record of FIG. 5), which indicates that the advertiser C11 has the advertising right in the advertising space A, as it is.

In addition, when the resale request is received by the request receiving unit 137, the service providing unit 132 provides, as a resale service, an auction service for the advertising right for resale. Specifically, similarly to the process before the resale request is received, the service providing unit 132 provides an auction page to the advertiser terminal 20 when a request for the auction page is received from the advertiser terminal 20. Then, the service providing unit 132 receives bid information including the bid price from the advertiser terminal 20 through the auction page.

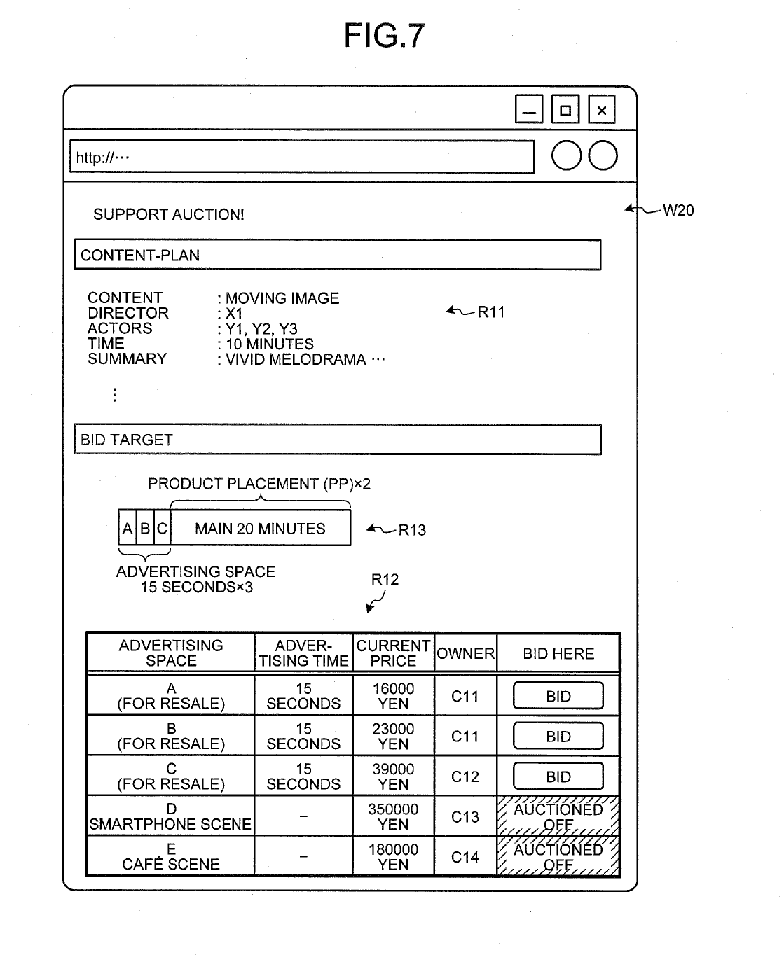

Here, FIG. 7 illustrates an example of the auction page generated by the service providing unit 132 according to the embodiment. FIG. 7 illustrates an example of an auction page W20 corresponding to the plan ID “P11” illustrated in FIG. 5. As in the example illustrated in FIG. 7, the service providing unit 132 publishes the advertising space information and the like for each auction ID, which are stored in the auction storage unit 121 so as to match the plan ID “P11”, in a bid display field R12 of the auction page W20. Specifically, in the example illustrated in FIG. 5, the advertising right in the advertising spaces A, B, and C is for resale, and the advertising right in the advertising spaces D and E is not for resale. Therefore, the service providing unit 132 holds auctions for the advertising spaces A, B, and C for resale, but does not hold auctions for the advertising spaces D and E that are not for resale. In this case, the service providing unit 132 publishes that the advertising spaces A, B, and C are for resale. In the example of FIG. 7, the service providing unit 132 publishes the wording, such as “(resale)”, in the field of the advertising space. In addition, the service providing unit 132 publishes information (for example, a company name or the type of industry) regarding the advertiser of the resale source having the advertising right in the advertising spaces A, B, and C currently.

Thus, the service providing unit 132 publishes various kinds of information regarding all advertising spaces, which are set to the content, on the auction page even if the advertising right in some of the plurality of advertising spaces set to the content is for resale. For example, in the example of FIG. 7, the service providing unit 132 publishes various kinds of information regarding the advertising spaces D and E that are not for resale. In this manner, the service providing unit 132 can provide information, which will be helpful at the time of bidding, to advertisers participating in the resale service. For example, in the example of FIG. 7, it is assumed that the type of industry of the advertiser C13, who is an owner of the advertising right in the advertising spaces D and E, is a “car”. In this case, it can be thought that the advertiser C13 determines that the content is viewed by users having a high preference for the “car”. Therefore, for example, an advertiser whose type of industry is a “travel” can determine that the user having a high preference for the “car” also has a high preference for the “travel” and can bid for the auctions for the advertising spaces A to C being held. In addition, advertisers participating in the auctions for the advertising spaces A to C can grasp the rate of the winning bid price by referring to the winning bid price of the advertising right in other advertising spaces. Therefore, the service providing unit 132 can provide value-added services for advertisers.

In addition, the service providing unit 132 provides a resale service without changing the conditions of the advertising space set to the advertising space information. For example, the service providing unit 132 provides a resale service for reselling the right to display an advertisement in the advertising space without changing the reproduction position of the advertising space, the display time of the advertising space, the size (display size) of the advertising space, and the like.

In addition, the winning bid amount managing unit 133 manages winning bid amount received from the winning bidder who has made a successful bid for the advertising right for resale. Specifically, the winning bid amount managing unit 133 transfers the winning bid amount received from the winning bidder, who has made a successful bid for the advertising right for resale, to the advertiser who is a resale source of the advertising right. In addition, the winning bid amount managing unit 133 may perform only the process of calculating the amount of money to be transferred to the advertiser who is a resale source.

In addition, the content receiving unit 134 receives advertisement data from the winning bidder who has made a successful bid for the advertising right for resale. Then, the generating unit 135 generates new composite content by replacing advertisement data corresponding to the advertiser of the resale source, of the advertisement data incorporated in the generated composite content, with advertisement data corresponding to the advertiser of a resale destination. Then, the transmitting unit 136 transmits the new composite content generated by the generating unit 135 to the distribution server 30. Accordingly, when the new composite content is received from the transmitting unit 136, the distribution server 30 distributes the new composite content after the replacement of advertisement data to the user terminal 40.

4. Service Providing Procedure

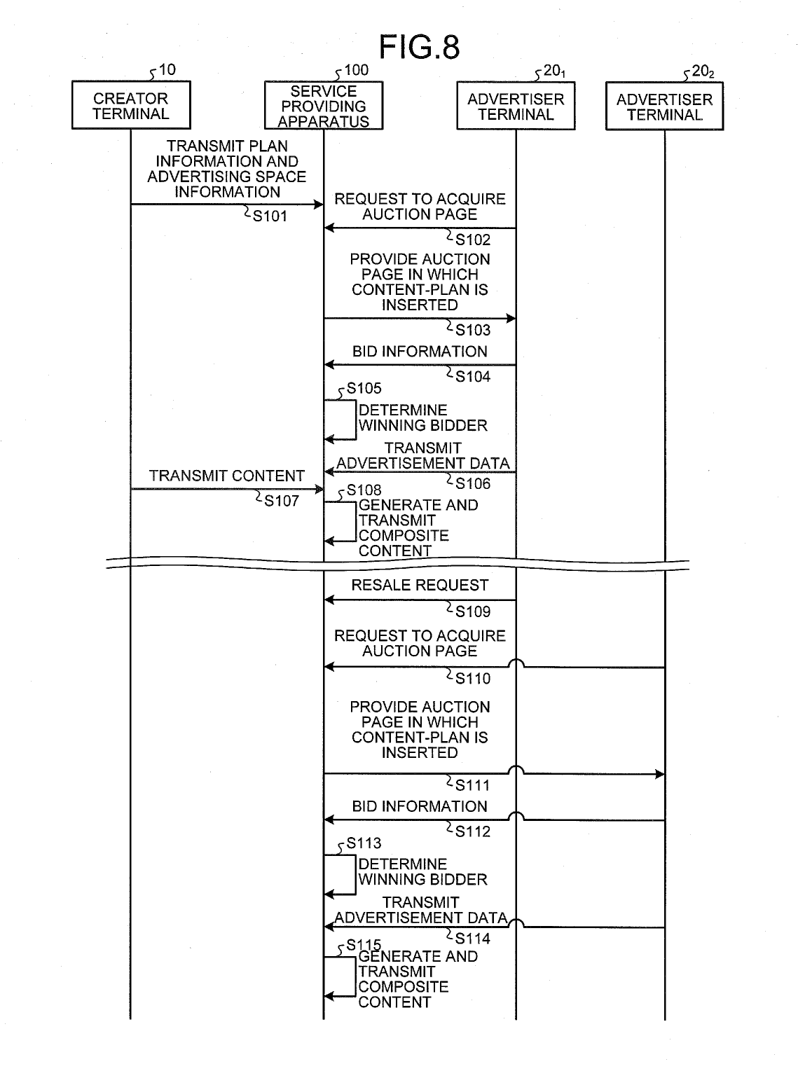

Next, the procedure of the service providing process of the service providing system 1 according to the embodiment will be described with reference to FIG. 8. FIG. 8 is a sequence diagram illustrating the service providing procedure of the service providing system 1 according to the embodiment. In addition, FIG. 8 illustrates an example where the advertising right is resold to the advertiser C12 who uses the advertiser terminal 20₂ from the advertiser C11 who uses the advertiser terminal 20₁.

As illustrated in FIG. 8, the content creator transmits the plan information and the advertising space information to the service providing apparatus 100 using the creator terminal 10 (step S101). In this case, the service providing apparatus 100 stores the plan information and the advertising space information in the auction storage unit 121.

In addition, in the example of FIG. 8, an example is illustrated in which the content creator transmits the plan information and the advertising space information at the same time. However, the content creator may transmit the plan information and the advertising space information at different times. For example, the content creator may transmit the advertising space information to the service providing apparatus 100 after transmitting the plan information. In addition, for example, the content creator may input various kinds of information to the submission site described above to transmit the plan information and the advertising space information to the service providing apparatus 100. In this case, the content creator may input the plan information to the submission site first, and input the advertising space information to the submission site in another day or the like.

Then, when a request to acquire an auction page is received from the advertiser terminal 20₁ (step S102), the service providing apparatus 100 provides the auction page having the content-plan inserted thereinto to the advertiser terminal 20₁ (step S103). Then, the service providing apparatus 100 receives bid information including the bid price from the advertiser terminal 20₁ through the auction page (step S104). Thus, the service providing apparatus 100 receives bid information from a plurality of advertiser terminals 20 including the advertiser terminal 20₁.

Then, the service providing apparatus 100 determines a winning bidder on the basis of the bid information received from the advertiser terminal 20 (step S105). For example, the service providing apparatus 100 determines an advertiser who has bid the highest price at the end date and time when the auction period has expired, as a winning bidder. In FIG. 8, it is assumed that the service providing apparatus 100 determines the advertiser C11 as a winning bidder. In this case, the service providing apparatus 100 manages the winning bid amount received from the advertiser C11. Then, when the content creator charges for the cost of production, the service providing apparatus 100 subtracts the cost from the winning bid amount and sends the cost to the content creator.

Then, the advertiser C11 transmits advertisement data to the service providing apparatus 100 using the advertiser terminal 20₁ (step S106). Then, when the content has been created, the content creator transmits the content to the service providing apparatus 100 using the creator terminal 10 (step S107).

Then, the service providing apparatus 100 incorporates the advertisement data received from the advertiser C11 into the content received from the content creator to generate composite content and transmits the generated composite content to the distribution server 30 (step S108). Accordingly, the distribution server 30 distributes the composite content to the user terminal 40.

Then, the advertiser C11 transmits a request to resell the advertising right using the advertiser terminal 20₁ (step S109). Then, when a request to acquire an auction page is received from the advertiser terminal 20₂ (step S110), the service providing apparatus 100 provides the auction page having the content-plan inserted thereinto to the advertiser terminal 20₂ (step S111). Then, the service providing apparatus 100 receives bid information including the bid price from the advertiser terminal 20₂ through the auction page (step S112).

Then, the service providing apparatus 100 determines a winning bidder based on the bid information received from the plurality of advertiser terminals 20 (step S113). In FIG. 8, it is assumed that the service providing apparatus 100 determines the advertiser C 12 as a winning bidder. In this case, the advertiser C12 transmits the advertisement data to the service providing apparatus 100 using the advertiser terminal 20₂ (step S114).

Then, the service providing apparatus 100 regenerates composite content by incorporating the advertisement data received in step S114 in the content received in step S107, and transmits the regenerated composite content to the distribution server 30 (step S115). Accordingly, the distribution server 30 distributes the new composite content to the user terminal 40.

5. Modifications

The service providing system 1 according to the embodiment described above may be implemented in various different forms other than the embodiment described above. Therefore, other embodiments of the service providing system 1 will be described below.

5-1. Resale Conditions (1)

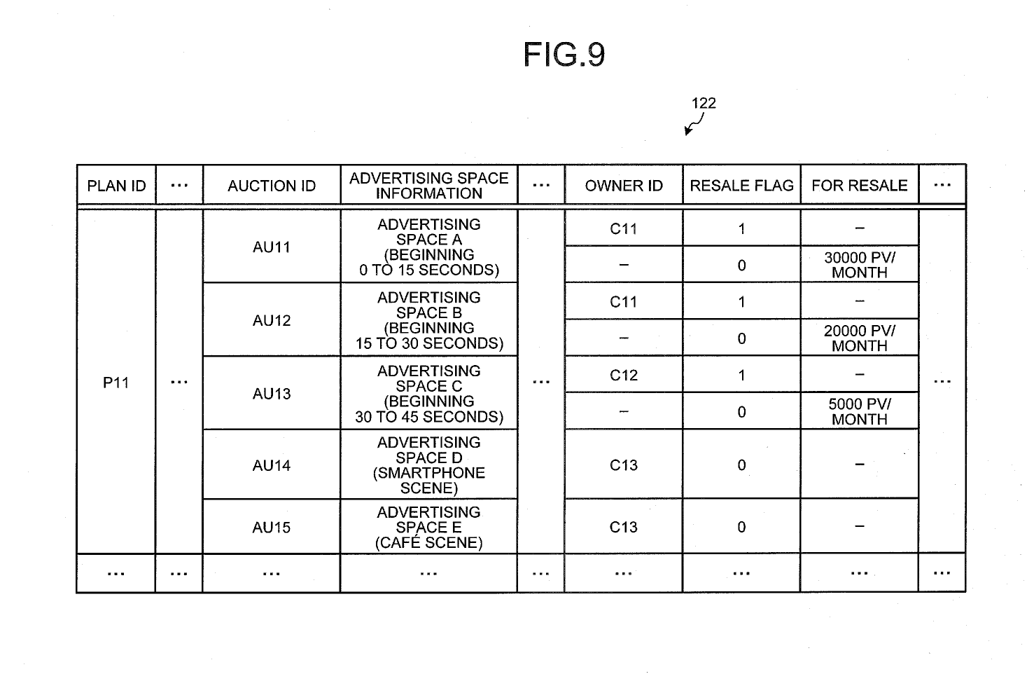

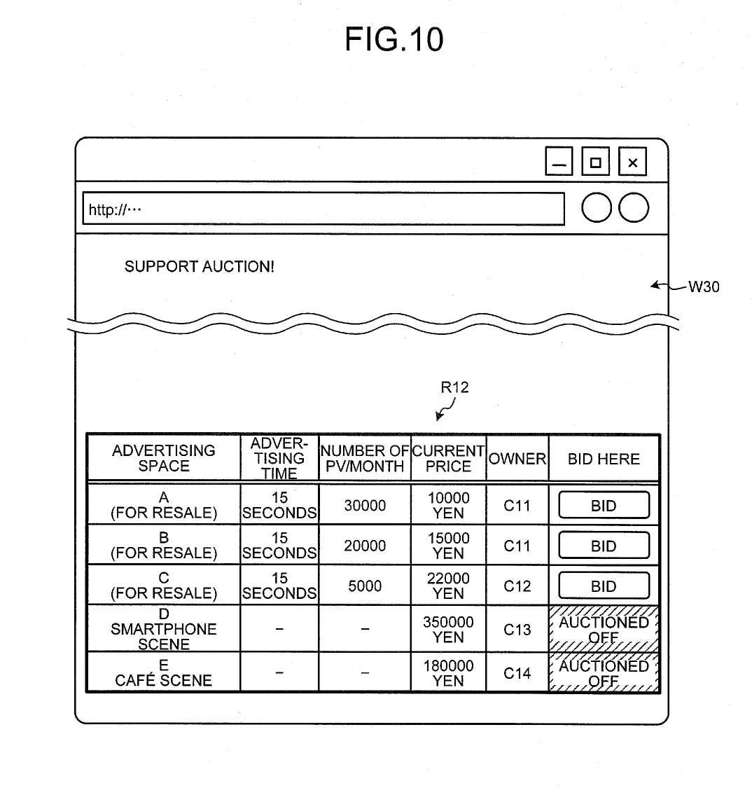

In the above embodiment, an example is illustrated in which the service providing apparatus 100 provides a resale service for reselling the entire advertising right. However, the service providing apparatus 100 may provide a resale service for reselling a part of the advertising right. For example, the request receiving unit 137 of the service providing apparatus 100 may receive a resale request to resell the right to display an advertisement by a predetermined number of times, which a part of the right to display an advertisement on the content. In addition, the service providing unit 132 of the service providing apparatus 100 may provide a resale service for reselling the right to display an advertisement by a predetermined number of times in response to the resale request received by the request receiving unit 137. This will be described with reference to FIGS. 9 and 10.

FIG. 9 is a diagram illustrating an example of an auction storage unit 122 according to a modification. The service providing apparatus 100 according to the modification includes the auction storage unit 122 illustrated in FIG. 9 instead of the auction storage unit 121 illustrated in FIGS. 4 and 5. As illustrated in FIG. 9, the auction storage unit 122 stores information, such as “for resale”. In addition, although not illustrated in FIG. 9, the auction storage unit 122 also stores “content-plan”, “auction period”, “current price”, “bidder ID”, and “end date and time” illustrated in FIGS. 4 and 5.

The “for resale” in FIG. 9 indicates the number of times of advertisement display. In the case of FIG. 9, the number of PV (page view) per month is used as a unit of the number of times by which an advertisement is displayed. That is, FIG. 9 illustrates an example where the advertiser C11 having the advertising right in the advertising space A resells an advertising right to display an advertisement in the advertising space A 30000 times per month. In addition, the number of PV per predetermined period (for example, per day or per week) may be stored in “for resale”, without being limited to the number of PV per month.

In the example of FIG. 9, the request receiving unit 137 of the service providing apparatus 100 receives a resale request from the advertiser having the advertising right together with the number of PV for resale in step S15 illustrated in FIG. 1. In this case, the request receiving unit 137 adds a record, in which the number of PV received from the advertiser is stored, in the auction storage unit 122 as in the example illustrated in FIG. 9.

Then, the service providing unit 132 of the service providing apparatus 100 generates an auction page based on the auction storage unit 122 illustrated in FIG. 9. Here, FIG. 10 illustrates an example of the auction page generated by the service providing unit 132 according to the modification. FIG. 10 illustrates an example of an auction page W30 corresponding to the plan ID “P11” illustrated in FIG. 9. As in the example illustrated in FIG. 10, the service providing unit 132 publishes “the number of PV/month” in the bid display field R12 of the auction page W30. Specifically, the service providing unit 132 publishes the number of PV, which is stored in “for resale” of the auction storage unit 122, in “the number of PV/month” of the bid display field R12.

Thus, the service providing unit 132 holds an auction for the advertising right to display an advertisement by the number of times designated by the advertiser. Therefore, the service providing apparatus 100 can provide value-added services for advertisers. For example, some advertisers may set the target number of times by which the advertisement is displayed. In practice, however, views (the number of distributions) of composite content may be larger than the target number of times of the advertiser. In addition, some advertisers may be satisfied with displaying the advertisement only by the target number of times without the need to display the advertisement more than the target number of times. Such an advertiser can resell the advertising right for the number of times, which is obtained by subtracting the target number of times of advertisement display from the monthly average of the number of times of distribution of composite content, by using the service providing apparatus 100 described with reference to FIGS. 9 and 10. Therefore, the service providing apparatus 100 can provide value-added services for advertisers.

In addition, in the example described above, when a resale request is received together with the number of PV for resale, the request receiving unit 137 may determine whether or not the number of PV can be guaranteed. For example, the service providing apparatus 100 acquires the number of times of distribution (for example, the number of times of distribution per month), by which composite content is distributed to the user terminal 40, from the distribution server 30 and holds the acquired number of times of distribution as history information. In addition, when a resale request is received together with the number of PV for resale, the request receiving unit 137 acquires the actual number of times of distribution of composite content, in which the advertisement for resale is added, from the history information. In addition, when the number of PV for resale is larger than the number of times of distribution acquired from the history information, the request receiving unit 137 may notify the transmission source of the resale request of the situation and may not receive the resale request. Alternatively, if the number of PV for resale is not smaller than the number of times of distribution acquired from the history information by a predetermined value or more, the request receiving unit 137 may notify the transmission source of the resale request of the situation and may not receive the resale request. For example, when the number of PV for resale is larger than a value (value decreased by 30%), which is obtained by subtracting a predetermined percentage from the number of times of distribution acquired from the history information, the request receiving unit 137 may not receive the resale request. Therefore, the service providing apparatus 100 can provide a resale service for reselling the number of PV guaranteed.

In the example illustrated in FIGS. 9 and 10, the generating unit 135 of the service providing apparatus 100 generates, for example, composite content in which advertisement data corresponding to the advertiser of the resale source is added, and composite content, in which advertisement data corresponding to the advertiser of the resale destination is added. For example, in the example of FIG. 10, it is assumed that the advertiser C12 has made a successful bid for the advertising space A. In this case, the generating unit 135 generates composite content, in which advertisement data corresponding to the advertiser C11 is incorporated into the advertising space A, and composite content, in which advertisement data corresponding to the advertiser C12 is incorporated into the advertising space A. Then, the transmitting unit 136 transmits both items of the composite content generated by the generating unit 135 and the resold number of PV to the distribution server 30. In this manner, the distribution server 30 distributes the composite content, in which the advertisement data corresponding to the advertiser C12 is incorporated, until the number of times reaches the resold number of PV, and the composite content, in which the advertisement data corresponding to the advertiser C11 is incorporated, after the number of times reaches the resold number of PV.

5-2. Resale Conditions (2)

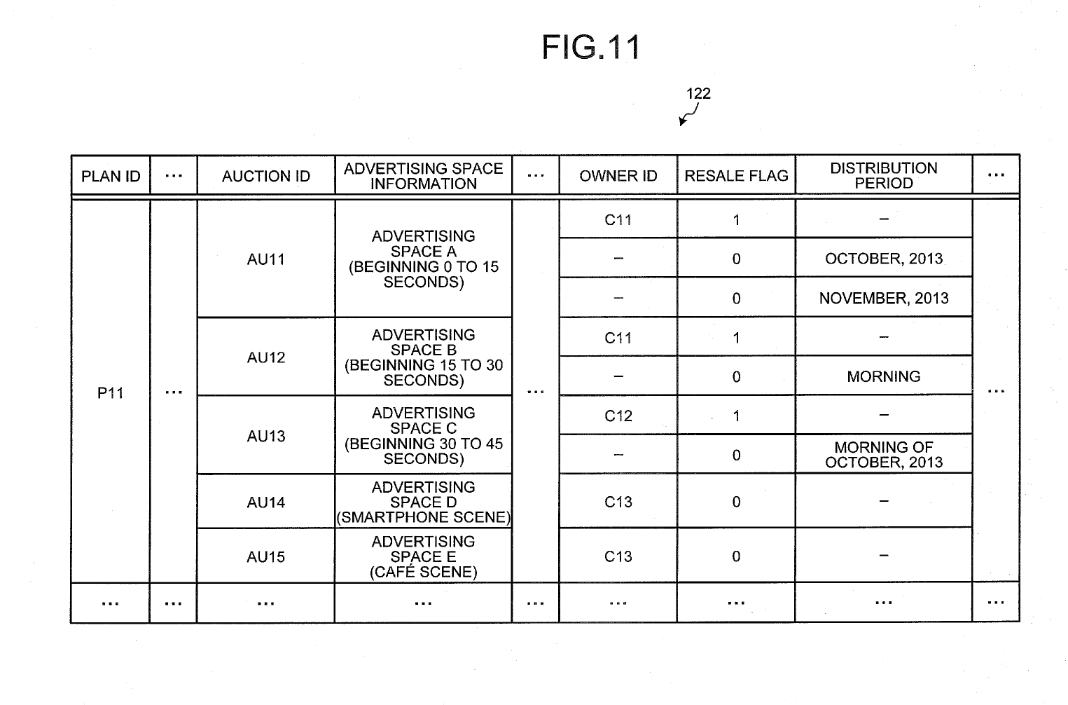

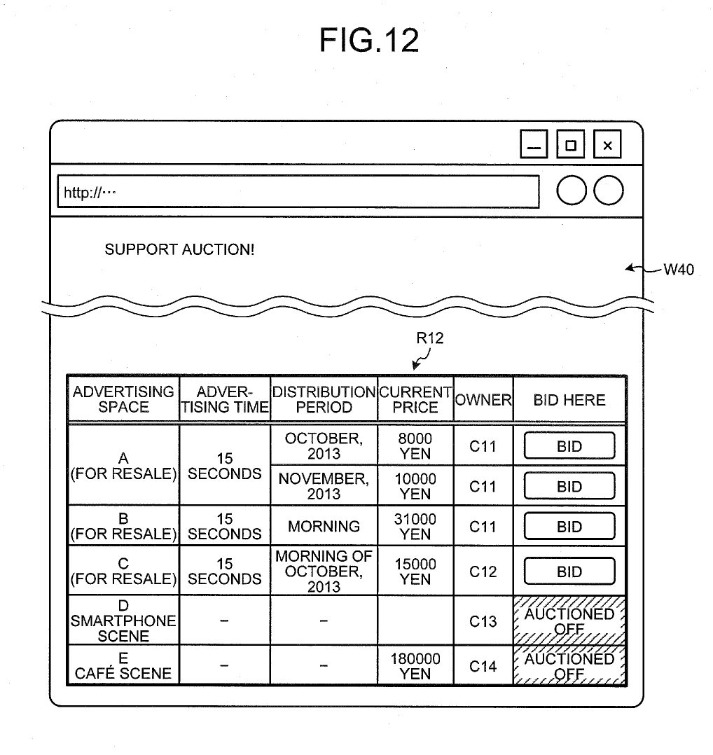

In FIGS. 9 and 10, an example is illustrated in which the advertising right, for which the number of times by which an advertisement is displayed is determined, is resold as a part of the advertising right. However, a part of the advertising right is not limited to this example. For example, the request receiving unit 137 of the service providing apparatus 100 may receive a resale request to resell the advertising right to display an advertisement in a predetermined period of time, which is a part of the advertising right. In addition, the service providing unit 132 of the service providing apparatus 100 may provide a resale service for reselling the advertising right to display an advertisement only in a predetermined period of time in response to the resale request received by the request receiving unit 137. This will be described with reference to FIGS. 11 and 12.

FIG. 11 is a diagram illustrating an example of the auction storage unit 122 according to the modification. The configuration of the auction storage unit 122 is the same as that in the example illustrated in FIG. 9. However, “for resale” in FIG. 11 indicates a period for which an advertisement is distributed. That is, FIG. 11 illustrates an example where the advertiser C11 having the advertising right in the advertising space A resells the advertising right to display an advertisement in the advertising space A of composite content distributed in October, 2013 and the advertising right to display an advertisement in the advertising space A of composite content distributed in November, 2013. In addition, FIG. 11 illustrates an example where the advertiser C11 resells the advertising right to display an advertisement in the advertising space B of composite content distributed in the morning. In addition, FIG. 11 illustrates an example where the advertiser C12 resells the advertising right to display an advertisement in the advertising space C of composite content distributed in the morning of October, 2013.

In the example of FIG. 11, the request receiving unit 137 of the service providing apparatus 100 receives a resale request from the advertiser having the advertising right together with an advertisement distribution period for resale in step S15 illustrated in FIG. 1. In this case, the request receiving unit 137 adds a record, in which the advertisement distribution period received from the advertiser is stored, in the auction storage unit 122 as in the example illustrated in FIG. 9. In this case, the request receiving unit 137 may receive a plurality of resale requests. In this case, the request receiving unit 137 adds a record by the number of resale requests received from the advertiser, as in the example of auction ID “AU11” illustrated in FIG. 11.

Then, the service providing unit 132 of the service providing apparatus 100 generates an auction page based on the auction storage unit 122 illustrated in FIG. 11. Here, FIG. 12 illustrates an example of the auction page generated by the service providing unit 132 according to the modification. FIG. 12 illustrates an example of an auction page W40 corresponding to the plan ID “P11” illustrated in FIG. 11. As in the example illustrated in FIG. 12, the service providing unit 132 publishes a “distribution period” in the bid display field R12 of the auction page W40. Specifically, the service providing unit 132 publishes an advertisement distribution period, which is stored in “for resale” of the auction storage unit 122, in the “distribution period” of the bid display field R12.

Thus, the service providing unit 132 holds an auction for the advertising right to display an advertisement for a period designated by the advertiser. Therefore, the service providing apparatus 100 can provide value-added services for advertisers. For example, some advertisers may set the time (season) or time zone for which an advertisement needs to be displayed. Such an advertiser can resell the advertising right for the time (season) or time zone, for which no advertisement needs to be displayed, by using the service providing apparatus 100 described with reference to FIGS. 11 and 12. Therefore, the service providing apparatus 100 can provide value-added services for advertisers.

In the example illustrated in FIGS. 11 and 12, the generating unit 135 of the service providing apparatus 100 generates, for example, composite content in which advertisement data corresponding to the advertiser of the resale source is incorporated, and composite content, in which advertisement data corresponding to the advertiser of the resale destination is incorporated. Then, the transmitting unit 136 transmits the composite content generated by the generating unit 135 to the distribution server 30 so as to match the distribution period. Thus, in each distribution period, the distribution server 30 distributes the composite content corresponding to the distribution period.

5-3. Resale Conditions (3)

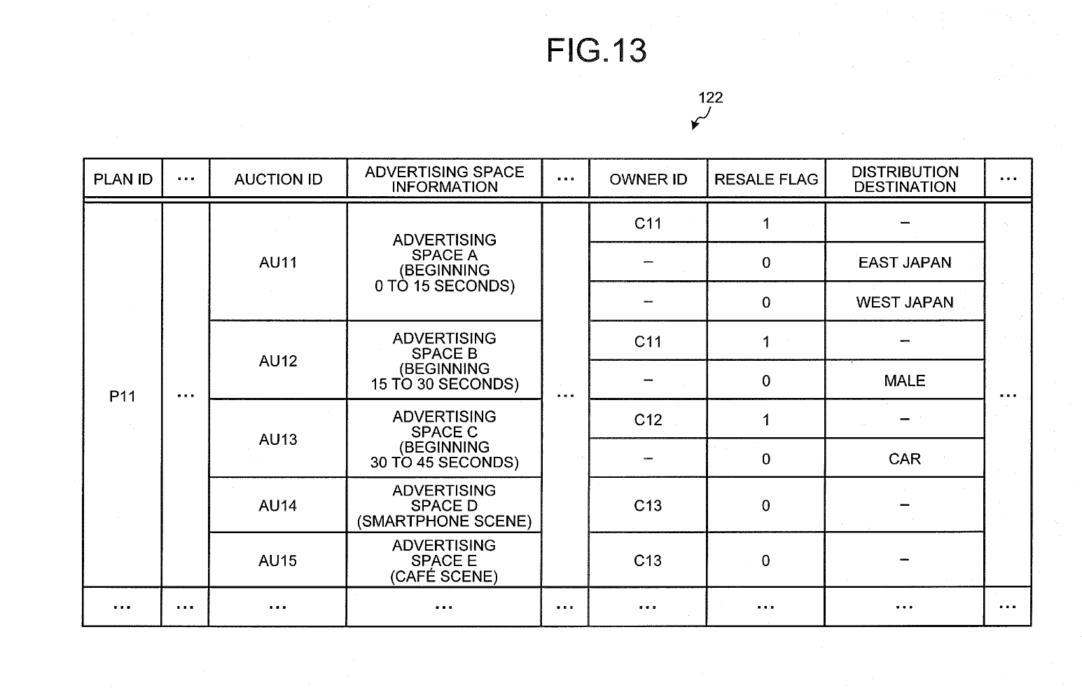

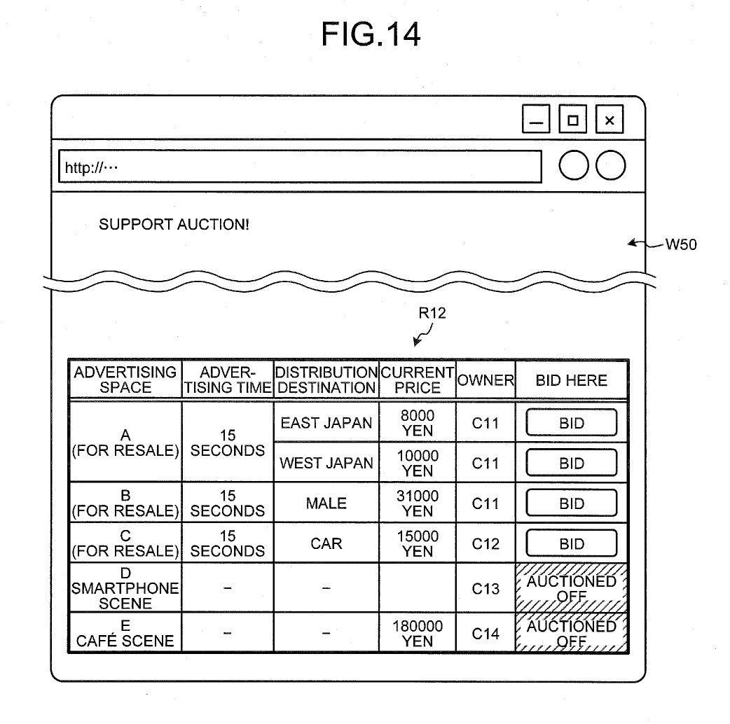

In addition, a part of the advertising right is not limited to the example illustrated in FIGS. 9 to 12. For example, the request receiving unit 137 of the service providing apparatus 100 may receive a resale request to resell the advertising right to display an advertisement on the content distributed to a predetermined user, which is a part of the advertising right. In addition, the service providing unit 132 of the service providing apparatus 100 may provide a resale service for reselling the advertising right in the content distributed to a predetermined user in response to the resale request received by the request receiving unit 137. This will be described with reference to FIGS. 13 and 14.

FIG. 13 is a diagram illustrating an example of the auction storage unit 122 according to the modification. The configuration of the auction storage unit 122 is the same as that in the example illustrated in FIG. 9. However, “for resale” in FIG. 13 indicates information regarding the distribution destination of composite content in which an advertisement is displayed. For example, “for resale” in FIG. 13 corresponds to various user attributes of a user who becomes a distribution destination of composite content. For example, user attributes are demographic attributes or psychographic attributes. Demographic attributes indicate the attribution information of demographic users. For example, the demographic attributes correspond to user's “address”, “sex”, “age”, “annual income”, “occupation”, “family structure”, and the like. In addition, psychographic attributes indicate user's preferences, values, lifestyle, personality, and the like. For example, the psychographic attributes correspond to “car”, “travel”, “clothes”, “food”, and the like as a field of preference of the user.

In addition, in the example of FIG. 13, the advertising right for resale corresponds to the right to display an advertisement on composite content distributed to the user having user attributes stored in “for resale”. That is, FIG. 13 illustrates an example where the advertiser C11 having the advertising right in the advertising space A resells the advertising right to display an advertisement in the advertising space A of composite content distributed to the user living in the East Japan and the advertising right to display an advertisement in the advertising space A of composite content distributed to the user living in the West Japan. In addition, FIG. 13 illustrates an example where the advertiser C11 resells the advertising right to display an advertisement in the advertising space B of composite content distributed to the user having a user attribute as a male. In addition, FIG. 13 illustrates an example where the advertiser C12 resells the advertising right to display an advertisement in the advertising space C of composite content distributed to the user having a high preference for a car.

In the example of FIG. 13, the request receiving unit 137 of the service providing apparatus 100 receives a resale request from the advertiser having the advertising right together with the user attributes of the distribution destination for resale in step S15 illustrated in FIG. 1. In this case, the request receiving unit 137 adds a record, in which the user attributes received from the advertiser are stored, in the auction storage unit 122 as in the example illustrated in FIG. 9. In this case, the request receiving unit 137 may receive a plurality of resale requests. In this case, the request receiving unit 137 adds a record by the number of resale requests received from the advertiser, as in the example of auction ID “AU11” illustrated in FIG. 13. In addition, although FIG. 13 illustrates an example where there is a single user attribute for resale, the request receiving unit 137 may receive a resale request together with a plurality of user attributes. For example, the request receiving unit 137 may receive user attributes, such as “East Japan resident” and “male”. This example illustrates that the advertiser resells the advertising right in the advertising space of composite content distributed to the user who is “East Japan resident” and “male”.

Then, the service providing unit 132 of the service providing apparatus 100 generates an auction page based on the auction storage unit 122 illustrated in FIG. 13. Here, FIG. 14 illustrates an example of the auction page generated by the service providing unit 132 according to the modification. FIG. 14 illustrates an example of an auction page W50 corresponding to the plan ID “P11” illustrated in FIG. 13. As in the example illustrated in FIG. 14, the service providing unit 132 publishes a “distribution destination” in the bid display field R12 of the auction page W50. Specifically, the service providing unit 132 publishes user attributes, which are stored in “for resale” of the auction storage unit 122, in the “distribution destination” of the bid display field R12.

Thus, the service providing unit 132 holds an auction for the advertising right in composite content distributed to the distribution destination designated by the advertiser. Therefore, the service providing apparatus 100 can provide value-added services for advertisers. For example, some advertisers may distribute an advertisement only to a predetermined user. As an example, a dealer who mainly has a store in the East Japan may desire to distribute an advertisement only to users living in the East Japan. In addition, as another example, a cosmetics-related dealer may desire to distribute an advertisement only to female users. Such an advertiser can resell user attributes, for which no advertisement needs to be distributed, by using the service providing apparatus 100 described with reference to FIGS. 13 and 14. Therefore, the service providing apparatus 100 can provide value-added services for advertisers.

In the example illustrated in FIGS. 13 and 14, the generating unit 135 of the service providing apparatus 100 generates, for example, composite content in which advertisement data corresponding to the advertiser of the resale source is incorporated, and composite content, in which advertisement data corresponding to the advertiser of the resale destination is incorporated. Then, the transmitting unit 136 transmits the composite content generated by the generating unit 135 to the distribution server 30 so as to match the user attributes. Then, the distribution server 30 changes the composite content to be distributed according to the user attributes of the user at the distribution destination of the composite content.

In addition, in the example of FIGS. 13 and 14, the advertiser can determine user attributes for resale based on the distribution record of composite content. For example, the service providing apparatus 100 acquires the number of distributions for each targeting condition in each item of composite content from the distribution server 30 by periodically accessing the distribution server 30. Then, the service providing apparatus 100 provides the number of distributions for each targeting condition to the advertiser. Therefore, the advertiser can grasp the distribution regarding the user attributes of users who viewed the composite content in which the advertisement data of the advertiser is incorporated. For example, the advertiser can grasp that the male to female ratio of users who viewed the composite content is 3:7. In addition, based on such a distribution record of composite content, the advertiser can set only the user attribute “female” for resale and the user attribute “male” not for resale. In addition, the resale conditions illustrated in FIGS. 9 to 14 are examples, and resale conditions are not limited to the examples described above. Specifically, the various resale conditions illustrated in FIGS. 9 to 14 may be combined. For example, the advertiser can also resell the advertising right to display an advertisement on composite content distributed to the user who is a male in October, 2013.

5-4. Check for an Advertiser

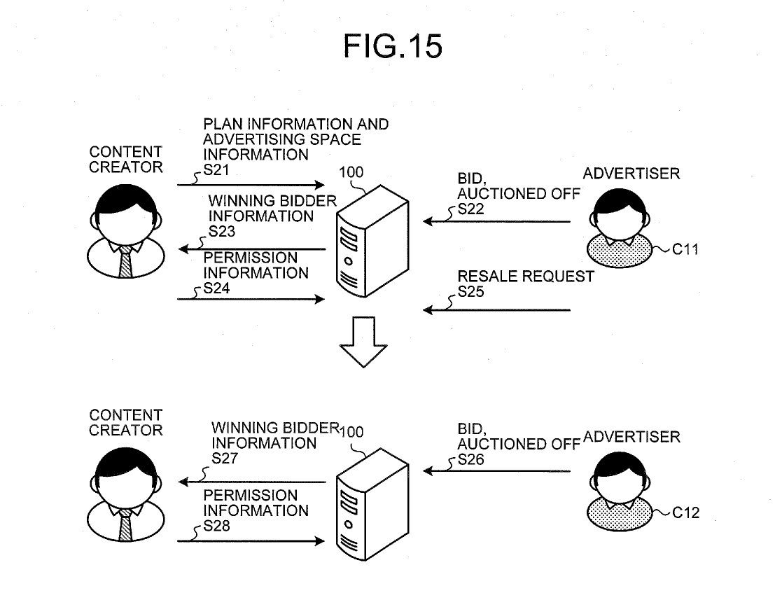

In addition, the service providing apparatus 100 described above may notify a content creator of winning bidder information regarding an advertiser who is a winning bidder when a winning bidder is determined. In addition, the service providing apparatus 100 may receive permission information, which indicates whether or not to accept the winning bidder, from the content creator who has received the winning bidder information. This will be described with reference to FIG. 15.

FIG. 15 is a diagram illustrating an example of the service providing process according to the modification. In the example of FIG. 15, the plan receiving unit 131 of the service providing apparatus 100 receives plan information and advertising space information from the content creator as in the example of FIG. 1 (step S21).

In addition, in the example of FIG. 15, the service providing unit 132 receives a bid from the advertiser C11, and determines the advertiser C11 as a winning bidder (step S22). In this case, the service providing unit 132 notifies the content creator of winning bidder information indicating that the advertiser C11 has been determined as a winning bidder (step S23). For example, the service providing unit 132 notifies the content creator of the winning bidder information indicating the name (company name or the like) of the advertiser C11 or the type of industry.

Then, the service providing unit 132 receives permission information, which indicates whether or not to accept the advertiser C11 as a winning bidder, from the content creator (step S24). In this case, when permission information indicating that the advertiser C11 is not accepted as a winning bidder is received, the service providing unit 132 notifies the advertiser C11 that the advertiser C11 is not accepted as a winning bidder. Then, the service providing unit 132 holds again an auction for the advertising right auctioned off in step S22. On the other hand, when permission information indicating that the advertiser C11 is accepted as a winning bidder is received, the service providing unit 132 notifies the advertiser C11 that the advertiser C11 is accepted as a winning bidder, and ends the auction for the advertising right auctioned off in step S22.

Thus, the service providing apparatus 100 can provide value-added services for the content creator by notifying the content creator of winning bidder information so that the content creator determines whether or not the winning bidder is appropriate. Specifically, the content creator can select an advertiser, who matches an image of the content being planned (or created content), based on the winning bidder information. For example, when producing the sports-related content, the content creator can select only an advertiser who is a sports trader. In addition, for example, the content creator can eliminate an advertiser who degrades the image of the content.

In the example of FIG. 15, the content creator accepts the advertiser C11 as a winning bidder. Then, the request receiving unit 137 of the service providing apparatus 100 receives a request to resell the advertising right auctioned off in step S22 from the advertiser C11 (step S25). Then, the service providing unit 132 receives a bid from the advertiser C12 in the auction for the advertising right for resale, and determines the advertiser C12 as a winning bidder (step S26).

In this case, the service providing unit 132 notifies the content creator of winning bidder information indicating that the advertiser C12 has been determined as a winning bidder, as in the example described above (step S27). That is, the service providing unit 132 notifies the content creator of information regarding the resale destination. Then, the service providing unit 132 receives permission information, which indicates whether or not to accept the advertiser C12 as a winning bidder, from the content creator (step S28). In this case, as in the example described above, the service providing unit 132 determines whether or not to accept the advertiser C12 as a winning bidder according to the permission information received from the content creator.

Thus, even when holding an auction for the advertising right for resale, the service providing apparatus 100 notifies the content creator of the winning bidder information indicating the advertiser of the resale destination so that the content creator determines whether or not the winning bidder is appropriate. In this manner, since the content creator can check the advertiser of the resale destination whenever the advertising right is resold, it is possible to maintain the image of the created content. Therefore, the service providing apparatus 100 can provide value-added services not only for advertisers but also for content creators.

5-5. Advertising Conditions

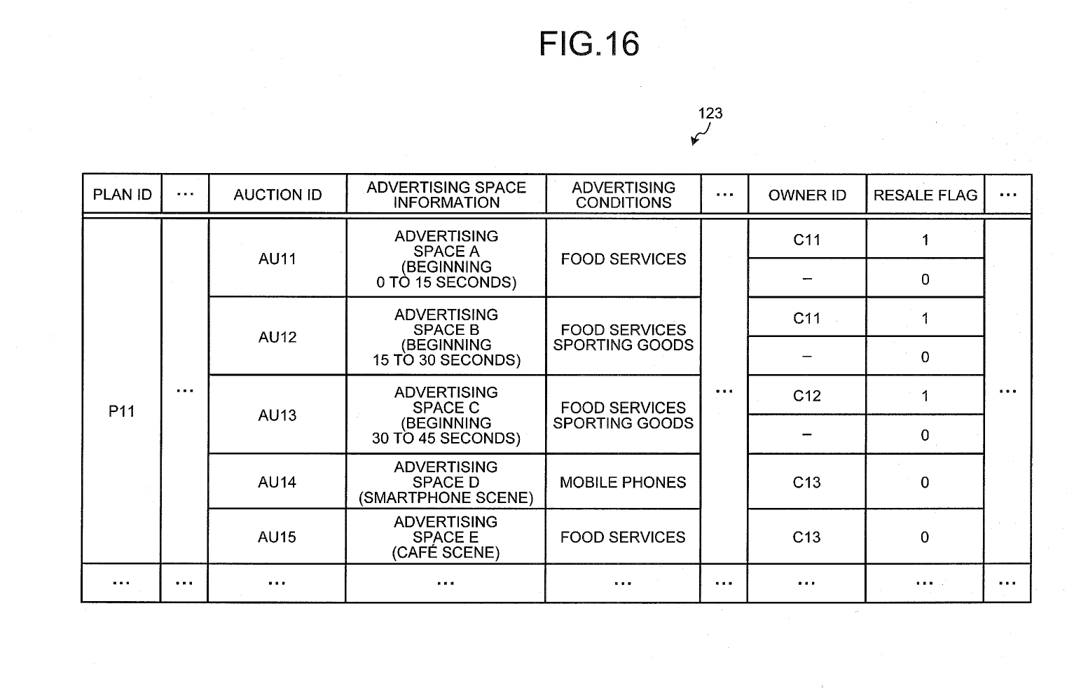

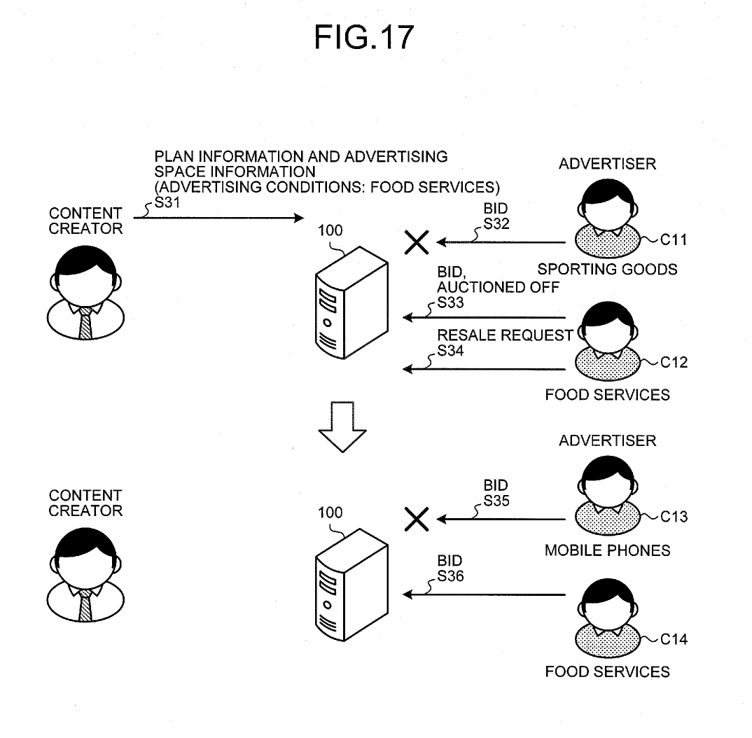

In addition, the service providing apparatus 100 described above may receive the advertising conditions, which are conditions of the advertisement displayed on the content, from the content creator and provide an auction service (including a resale service) in the range where the received advertising conditions are satisfied. This will be described with reference to FIGS. 16 and 17. In addition, FIGS. 16 and 17 illustrate examples where the advertising conditions are conditions of biddable advertisers.

FIG. 16 is a diagram illustrating an example of an auction storage unit 123 according to the modification. The service providing apparatus 100 according to the modification includes the auction storage unit 123 illustrated in FIG. 16 instead of the auction storage unit 121 illustrated in FIGS. 4 and 5. As illustrated in FIG. 16, the auction storage unit 123 stores information, such as “advertising conditions”. In addition, although not illustrated in FIG. 16, the auction storage unit 123 also stores “content-plan”, “auction period”, “current price”, “bidder ID”, and “end date and time” illustrated in FIGS. 4 and 5.

The “advertising conditions” indicate conditions of an advertisement allowed to be displayed on the content. In the example of FIG. 16, the type of industry of the advertiser who can bid for an auction is stored in the “advertising conditions”. That is, FIG. 16 illustrates an example where an advertiser whose type of industry is “food services” can bid for an auction for the advertising space A and an advertiser whose type of industry is “food services” or “sporting goods” can bid for an auction for the advertising space B.

FIG. 17 is a diagram illustrating an example of the service providing process according to the modification. In the example of FIG. 17, the plan receiving unit 131 of the service providing apparatus 100 receives plan information and advertising space information from the content creator (step S31). In this case, the plan receiving unit 131 receives advertising space information including the conditions of the advertiser allowed to bid for the auction. Then, the plan receiving unit 131 stores the conditions of the advertiser, which are included in the advertising space information, in the advertising conditions of the auction storage unit 123.

Then, the service providing unit 132 holds an auction for each advertising space, and receives a bid from each advertiser. In FIG. 17, an auction for the advertising space A illustrated in FIG. 16 will be described as an example. In addition, in the example of FIG. 17, it is assumed that the type of industry of the advertiser C11 is sporting goods, the type of industry of the advertiser C12 is food services, the type of industry of the advertiser C13 is mobile phones, and the type of industry of the advertiser C14 is food services.

Then, when a bid for the auction for the advertising space A is offered from the advertiser C11, the service providing unit 132 refuses the bid (step S32). This is because the type of industry “sporting goods” of the advertiser C11 does not match the type of industry “food services” of the advertiser who can bid for the advertising space A. On the other hand, when a bid for the auction for the advertising space A is offered from the advertiser C12, the service providing unit 132 accepts the bid (step S33). This is because the type of industry “food services” of the advertiser C12 matches the type of industry “food services” of the advertiser who can bid for the advertising space A.

Thus, the service providing apparatus 100 accepts a bid from the advertiser designated in advance by the content creator. Therefore, the content creator can select an advertiser, who matches an image of the content being planned (or created content), in advance. Therefore, the service providing apparatus 100 can provide value-added services for content creators.

Here, it is assumed that the advertiser C12 has been determined as a winning bidder of an auction for the advertising space A. Then, the request receiving unit 137 of the service providing apparatus 100 receives a request to resell the advertising right auctioned off in step S33 from the advertiser C12 (step S34).

Then, when a bid for the auction for the advertising right for resale is offered from the advertiser C13, the service providing unit 132 refuses the bid (step S35). This is because the type of industry “mobile phones” of the advertiser C13 does not match the type of industry “food services” of the advertiser who can bid for the advertising space A. On the other hand, when a bid for the auction for the advertising right for resale is offered from the advertiser C14, the service providing unit 132 accepts the bid (step S36). This is because the type of industry “food services” of the advertiser C14 matches the type of industry “food services” of the advertiser who can bid for the advertising space A.

Thus, the service providing apparatus 100 provides a resale service for the advertising right for resale in the range where the advertising conditions designated by the content creator in the planning stage are satisfied. In this manner, the content creator can maintain the image of the created content even if the advertising right is resold. Therefore, the service providing apparatus 100 can provide value-added services not only for advertisers but also for content creators.

In addition, although the type of industry of the advertiser has been described above as an example of the advertising conditions, the advertising conditions are not limited to this example. For example, the advertising conditions may be the type of advertisement data. In this case, the content creator can designate the type of advertisement data as either a still image or a moving image or can designate the type of advertisement data as either a live-action moving image or an animation. In addition, when the advertising conditions are the type of advertisement data, the service providing unit 132 determines whether or not the type of advertisement data received from a winning bidder by the content receiving unit 134 satisfies the advertising conditions. Then, when the advertising conditions are not satisfied, the service providing unit 132 notifies the winning bidder that advertisement data satisfying the advertising conditions is to be submitted or holds an auction again.

In addition, the service providing unit 132 may publish the advertising conditions described above on the auction page. In this case, since the advertiser can grasp the advertising conditions in a state before bidding, the service providing unit 132 can provide value-added services for advertisers.

5-6. Commission (1)

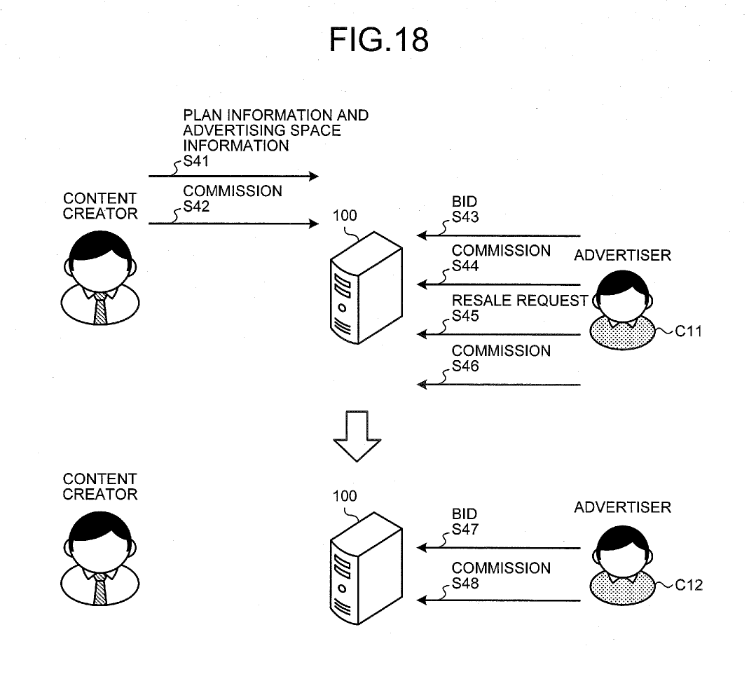

In addition, the service providing apparatus 100 described above may collect a commission from content creators or advertisers who use various services. This will be described with reference to FIG. 18.

FIG. 18 is a diagram illustrating an example of the service providing process according to the modification. In the example of FIG. 18, the plan receiving unit 131 of the service providing apparatus 100 receives plan information and advertising space information from the content creator (step S41). In this case, the service providing unit 132 charges the content creator a commission as a fee for the auction service (step S42).

In addition, the service providing unit 132 receives a bid from the advertiser C11 (step S43). In this case, the service providing unit 132 charges the advertiser C11 a commission as a fee for the auction service (step S44). For example, the service providing unit 132 charges the advertiser C11 a commission when providing the auction page illustrated in FIG. 6 to the advertiser C11. Thus, the service providing apparatus 100 can prevent content-plan from being unnecessarily viewed by advertisers, who have no intention to participate in the auction, by collecting a commission when the advertisers view the content-plan.

In addition, in the example of FIG. 18, the service providing unit 132 determines the advertiser C11 as a winning bidder. Then, the request receiving unit 137 receives a request to resell the advertising right from the advertiser C11 (step S45). In this case, the service providing unit 132 charges the advertiser C11 a commission as a fee for the resale service (step S46).

Then, the service providing unit 132 receives a bid for the auction for the advertising right for resale from the advertiser C12 (step S47). In this case, the service providing unit 132 charges the advertiser C12 a commission as a fee for the resale service (step S48). For example, the service providing unit 132 charges the advertiser C12 a commission when providing the auction page illustrated in FIG. 7 to the advertiser C12. Thus, the service providing apparatus 100 can prevent content-plan from being unnecessarily viewed by advertisers, who have no intention to participate in the auction, by collecting a commission when the advertisers view the content-plan.

Thus, the service providing apparatus 100 may charge the content creator or the advertiser a commission for providing the auction service (including the resale service). In this manner, the service providing apparatus 100 can prevent the auction service from being used for window-shopping.

In addition, although FIG. 18 illustrates an example where the service providing unit 132 charges or collects a commission, the service providing unit 132 may perform only the process of calculating the amount of commission. In addition, the administrator or the like of the service providing apparatus 100 may charge the content creator or the advertiser the amount calculated by the service providing unit 132. In addition, the process of calculating the amount of commission may be performed by the winning bid amount managing unit 133 instead of the service providing unit 132.

5-7. Commission (2)

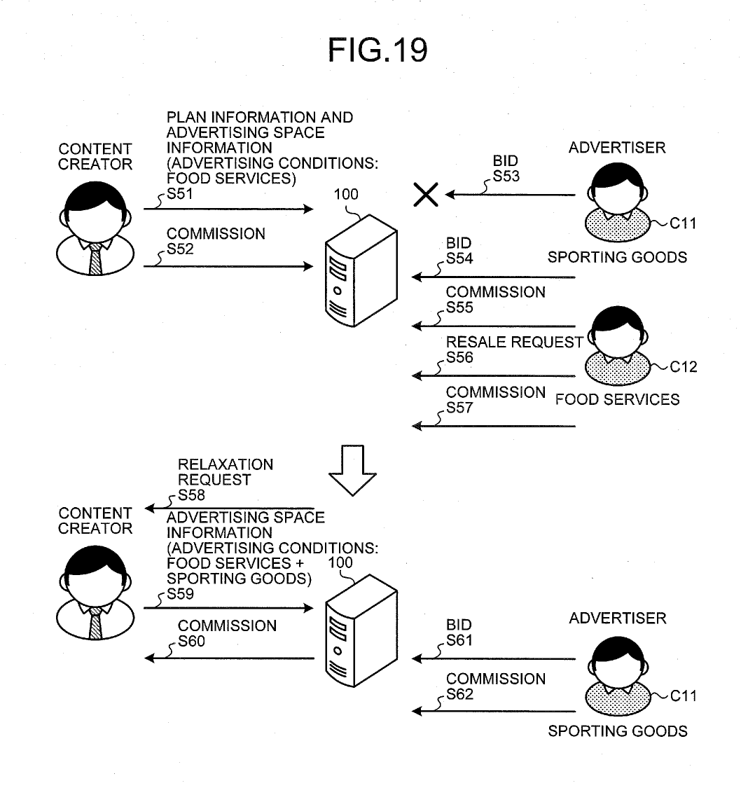

In addition, as in the example of FIG. 17, when providing an auction service in the range where the advertising conditions are satisfied, the service providing apparatus 100 may request a content creator to relax the advertising conditions instead of paying the content creator a commission. This will be described with reference to FIG. 19.

FIG. 19 is a diagram illustrating an example of the service providing process according to the modification. Step S51 illustrated in FIG. 19 corresponds to step S31 illustrated in FIG. 17. In addition, step S52 illustrated in FIG. 19 corresponds to step S42 illustrated in FIG. 18. In addition, step S53 illustrated in FIG. 19 corresponds to step S32 illustrated in FIG. 17. In addition, steps S54 to S57 illustrated in FIG. 19 correspond to steps S43 to S46 illustrated in FIG. 18.

Then, in the example of FIG. 19, when the request receiving unit 137 receives a resale request in step S56, the service providing unit 132 transmits a relaxation request for the relaxation of the advertising conditions to the content creator (step S58). Specifically, in the example of FIG. 19, the content creator limits the type of industry of biddable advertisers to food services by transmitting the advertising space information in step S51. Therefore, the service providing unit 132 requests the content creator to relax the limitation on the type of industry of the advertiser.

Then, the plan receiving unit 131 receives advertising space information including advertising conditions, which are more relaxed than the advertising conditions received in step S51, from the content creator rather (step S59). In the example of FIG. 19, the plan receiving unit 131 receives advertising space information in which the type of industry “sporting goods” is added to the advertiser's conditions.

Then, when the advertising space information in which the advertising conditions are relaxed is received, the service providing unit 132 updates the auction storage unit 123 and pays the content creator a commission (step S60). For example, the service providing unit 132 pays the content creator all or part of the commission obtained from the advertiser C12 in step S57. In addition, the service providing unit 132 may perform only the process of calculating the amount of commission paid to the content creator.

Then, when there is a bid from the advertiser C11 whose type of industry is sporting goods, the service providing unit 132 accepts the bid (step S61). This is because the type of industry “sporting goods” of the advertiser C11 is included in the type of industry “food services” or “sporting goods” of the advertiser relaxed in step S59. In addition, step S62 illustrated in FIG. 19 corresponds to step S48 illustrated in FIG. 18.

Thus, the service providing apparatus 100 makes a content creator relax the advertising conditions instead of paying the content creator a commission. Therefore, since it is possible to relax the limitation on advertisers, the service providing apparatus 100 can provide value-added services for advertisers.

5-8. Resale Timing

In addition, although the example where the resale of the advertising right is performed after composite content is distributed to the distribution server 30 is illustrated in the embodiment described above, the resale timing is not limited to this example. Specifically, the service providing unit 132 may provide a resale service for reselling the advertising right before composite content is distributed.

In addition, when a plurality of advertising spaces are set to the content, the service providing apparatus 100 may hold auctions for the respective advertising spaces in different periods. For example, when a content creator is made to set the holding period of the auction for each advertising space, the service providing unit 132 may hold respective auctions in different periods. In addition, when a plurality of advertising spaces are set to the content, the service providing unit 132 may set a prompt decision price for each auction. In such a case, all auctions for the respective advertising spaces do not necessarily end at the same timing. That is, before the auction for the first advertising space of the plurality of advertising spaces set on the same content ends, the auction for the second advertising space may end. In such a case, the service providing unit 132 described above may provide a resale service for the second advertising space while holding the auction for the first advertising space.

5-9. Resale to Content Creator

In addition, the service providing apparatus 100 described above may make a content creator participate in the auction for the resale of the advertising right. Specifically, the service providing unit 132 may receive a bid from a content creator in the resale service. Therefore, the service providing unit 132 can make a content creator repurchase the advertising right. For example, a content creator may desire to provide a specific advertiser with the advertising right auctioned off to an advertiser. In addition, for example, a content creator may desire to incorporate advertisement data, which is created by the content creator himself or herself, into the advertising space corresponding to the advertising right auctioned off to an advertiser. The service providing unit 132 can meet the demands of such content creators by providing the resale service in which content creators can participate.

In addition, the service providing unit 132 may provide a resale service in which content creators are biddable in preference to advertisers. Specifically, the service providing unit 132 may provide a resale service, in which only content creators can participate, for a predetermined period of time after accepting resale requests from advertisers. In this manner, the service providing unit 132 can better meet the above-described demands of content creators.

5-10. Check of Composite Content

In addition, the service providing apparatus 100 described above may make a content creator or an advertiser check composite content when the composite content is generated. Specifically, before transmitting composite content generated by the generating unit 135 to the distribution server 30, the transmitting unit 136 of the service providing apparatus 100 transmits the composite content to the content creator or the advertiser corresponding to the advertisement data incorporated in the composite content. In addition, since the generating unit 135 generates new composite content whenever the advertising right is resold, the transmitting unit 136 transmits the generated composite content to the content creator or the advertiser whenever composite content is generated by the generating unit 135. Thus, the transmitting unit 136 inquires of the content creator and the advertiser if there is any problem in the composite content. Then, when a reply that there is no problem in the composite content is received from the content creator and the advertiser, the transmitting unit 136 transmits the composite content to the distribution server 30.

Thus, the service providing apparatus 100 can prevent the distribution of composite content to the user terminal 40, which is not intended by the content creator and the advertiser, by making the content creator and the advertiser check the composite content. Specifically, composite content obtained by incorporating advertisement data into the content by the service providing apparatus 100 is not the content itself created by the content creator. For this reason, for example, advertisement data that degrades the image of the content may be incorporated in the composite content. In addition, advertisement data may be incorporated into the content in a form that is not intended by the advertiser. For this reason, advertisement data may be incorporated into the content in a form of degrading the image of the advertiser. The service providing apparatus 100 can prevent the distribution of composite content, which degrades the image of the content creator or the advertiser, by making the content creator and the advertiser check the composite content. In addition, the service providing apparatus 100 may transmit the composite content to only one of the content creator and the advertiser, or may transmit the composite content to both the content creator and the advertiser.

5-11. Service Mode

In addition, the service providing apparatus 100 described above may provide a resale service that is not an auction format. Specifically, the service providing unit 132 may provide a resale service for selling the advertising right for resale. In this case, the request receiving unit 137 receives a resale request from the advertiser of the resale source together with a sales price. Then, when there is an access from other advertisers, the service providing unit 132 distributes a web page to sell the advertising right at the selling price received by the request receiving unit 137. Similarly, although the service providing apparatus 100 provides the auction service for the right to display an advertisement on the content being planned, a sales service for simple sales that is not the auction format may also be provided for the right to display an advertisement on the content being planned.

In addition, in the embodiment described above, an example is illustrated in which the service providing apparatus 100 provides an auction service for the advertising right to display an advertisement on the content being planned and provides a resale service for reselling the advertising right auctioned off in the auction service. However, the service providing unit 132 of the service providing apparatus 100 may provide a resale service for reselling an advertising right to display an advertisement on predetermined content to other advertisers from the advertiser having the advertising right without being limited to the advertising right auctioned off in the auction service described above. That is, the service providing apparatus 100 may provide the resale service illustrated in the lower part of FIG. 1 instead of providing the auction service illustrated in the upper part of FIG. 1. In addition, although the example where the service providing apparatus 100 generates composite content is illustrated in the embodiment described above, the process of generating the composite content may be performed by other apparatuses, such as the distribution server 30. In such a case, the service providing apparatus 100 illustrated in FIG. 3 may not include the plan receiving unit 131, the content receiving unit 134, the generating unit 135, the transmitting unit 136, or the like. In addition, the auction storage unit 121 illustrated in FIG. 4 may not store “plan ID” or “content-plan”, for example.

5-12. Presentation of the Predicted Number of PV

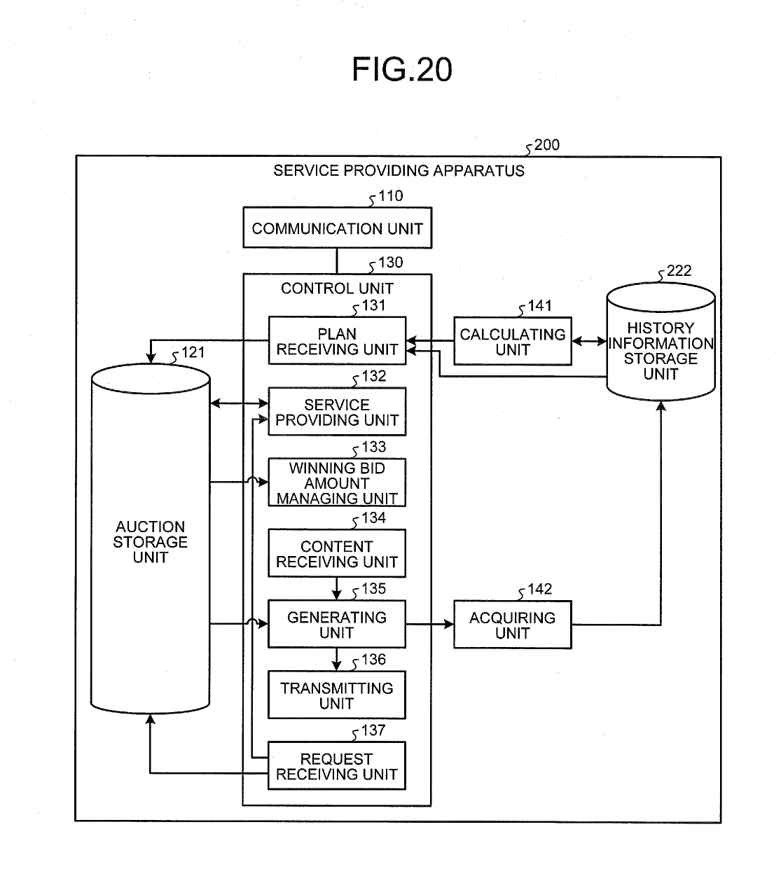

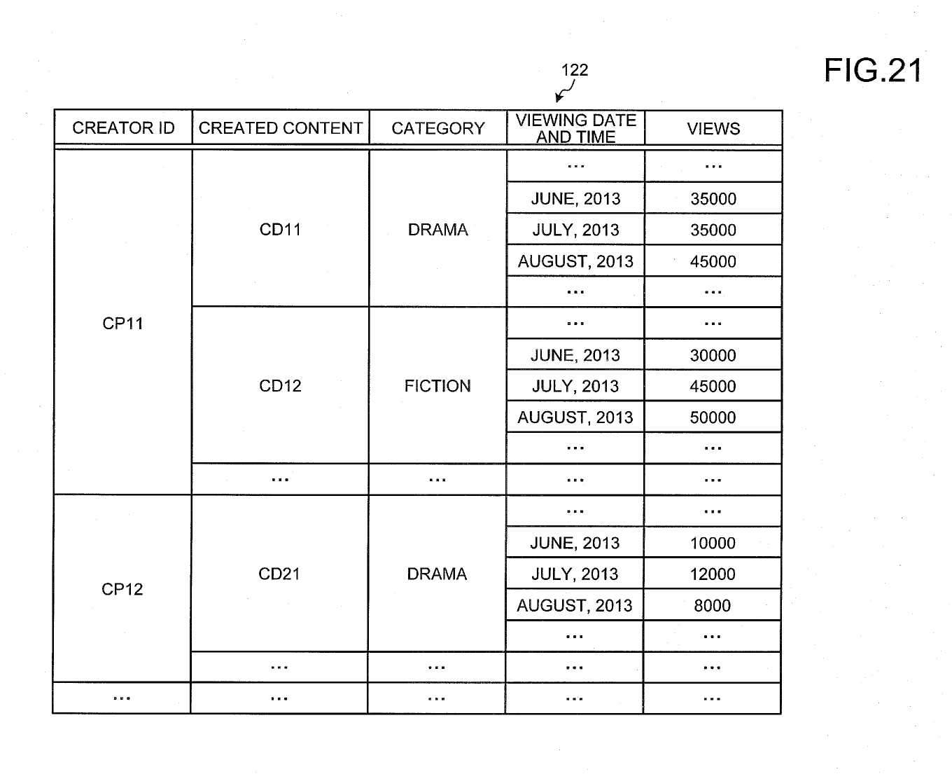

In addition, when providing the resale service, the service providing apparatus 100 described above may predict the number of times by which content is viewed by users and publish the prediction result on the auction page. Hereinafter, this point will be described with reference to FIGS. 20 and 21. In addition, the number of times by which content is viewed by users may be written as “the number of PV (page view)” below. In addition, the predicted value of the number of PV may be written as “the predicted number of PV” below.

FIG. 20 is a diagram illustrating an example of the structure of a service providing apparatus 200 according to the modification. As illustrated in FIG. 20, the service providing apparatus 200 includes a history information storage unit 222, a calculating unit 141, and an acquiring unit 142.

The history information storage unit 222 stores various kinds of information regarding the content created in the past by content creators. FIG. 21 illustrates an example of the history information storage unit 222 according to the modification. As illustrated in FIG. 21, the history information storage unit 222 has items, such as “creator ID”, “created content”, “category”, “viewing date and time”, and “views”.

The “creator ID” indicates identification information for identifying a content creator. The “created content” indicates content created in the past by content creators. In FIG. 21, an example is illustrated in which conceptual information, such as “CD11”, is stored in “created content”. In practice, however, content, such as a moving image, or a file path name indicating the storage location of content is stored. The “category” indicates a category to which created content belongs. Examples of categories of created content include drama, fiction, animation, and the like. In addition, for example, the category of content may be included in the plan information, and may be set by the content creator or may be set by the administrator of the service providing apparatus 200 or the distribution server 30 who checks the completed content. The “viewing date and time” indicates date and time when content is viewed. In the example of FIG. 21, information indicating the month and year of date and time is stored in “viewing date and time”. “Views” indicates the number of times by which content has been viewed. In other words, “views” indicates the number of times by which content (in practice, composite content to be described later) is distributed to the user terminal 40 by the distribution server 30. FIG. 21 illustrates an example where views in each month is stored in “views”.

That is, FIG. 21 illustrates an example where content “CD11” or “CD12” was created in the past by a content creator CP11. In addition, FIG. 21 illustrates an example where the content “CD11” is content (for example, a moving image) on dramas. In addition, FIG. 21 illustrates an example where the content “CD11” was viewed 35000 times in June, 2013, was viewed 35000 times in July, 2013, and was viewed 45000 times in August, 2013.

In addition, the history information storage unit 222 may not store the viewing date and time. Specifically, the history information storage unit 222 may store only the total number of views up to the present time from the distribution of created content.

The calculating unit 141 calculates the predicted number of PV that is the predicted value of the number of times by which content is viewed by users. Specifically, when a resale request is received by the request receiving unit 137, the calculating unit 141 acquires the plan information of content, in which an advertising space for resale is set, from the auction storage unit 121. Then, the calculating unit 141 calculates the predicted number of PV based on the acquired plan information and various kinds of information stored in the history information storage unit 222. For example, the calculating unit 141 calculates the predicted number of PV of the content corresponding to the plan information based on the views of the content created in the past by the content creator. Specifically, the calculating unit 141 specifies created content corresponding to the creator ID of the content creator among the items of created content stored in the history information storage unit 222. Then, based on the views corresponding to the specified created content, the calculating unit 141 calculates the predicted number of PV of the content being planned. For example, the calculating unit 141 calculates the average value of the views corresponding to the created content as the predicted number of PV. This is because the number of PV of the content, which is created by the same content creator, is in a fixed range.

The above calculation process will be described with reference to the example of FIG. 21. Here, it is assumed that the plan information is transmitted by the content creator CP11. In this case, the calculating unit 141 specifies the created content “CD11” and “CD12” whose creator ID is “CP11”. Then, the calculating unit 141 calculates the total number of views “115000” of the created content “CD11”, and calculates the total number of views “125000” of the created content “CD12”. Then, the calculating unit 141 calculates the average value “120000” of both the total numbers as the predicted number of PV. Alternatively, the calculating unit 141 may calculate a value, which is obtained by subtracting a predetermined percentage from the average value of the views, as the predicted number of PV.

In addition, as another aspect, the calculating unit 141 calculates the predicted number of PV of content corresponding to plan information based on the views of created content, which corresponds to the plan information received by the plan receiving unit 131, of created content created in the past by various content creators without being limited to the content creator who transmits the plan information. Specifically, the calculating unit 141 specifies created content matched with the category of the content included in the plan information, and calculates the predicted number of PV based on the views corresponding to the specified created content. This is because the number of PV of the content of the same category is in a fixed range in many cases. For example, it can be considered that the content on dramas generally tends to be viewed about 100,000 times and the content on animations generally tends to be viewed about 50,000 times.

The above calculation process will be described with reference to the example of FIG. 21. Here, it is assumed that the category of the content included in the plan information is a “drama”. In this case, the calculating unit 141 specifies the created content “CD11” and “CD21” whose category is “drama”. Then, the calculating unit 141 calculates the total number of views “115000” of the created content “CD11”, and calculates the total number of views “30000” of the created content “CD21”. Then, the calculating unit 141 calculates the average value “72500” of both the total numbers as the predicted number of PV.

The acquiring unit 142 acquires various kinds of information used when calculating the predicted number of PV of content. Specifically, the acquiring unit 142 stores the composite content generated by the generating unit 135 in the created content of the history information storage unit 222 so as to match the creator ID of the content creator. That is, the acquiring unit 142 stores the composite content generated by the generating unit 135 in the history information storage unit 222 as content created in the past by the content creator. However, the acquiring unit 142 may store the content received by the content receiving unit 134 in the created content of the history information storage unit 222 without being limited to this example.

In addition, the acquiring unit 142 acquires the number of distributions of each item of the composite content from the distribution server 30 by periodically accessing the distribution server 30. Then, the acquiring unit 142 stores the number of distributions of each item of composite content in the views of the history information storage unit 222 so as to match the composite content (created content). In this case, the acquiring unit 142 accumulates the number of distributions of each item of composite content that is acquired from the distribution server 30, and stores the views per predetermined period (for example, one month) in the views of the history information storage unit 222.

Then, the service providing unit 132 of the service providing apparatus 200 publishes the predicted number of PV calculated by the calculating unit 141 on the auction page, and provides the resale service described above. In this manner, the service providing apparatus 200 can make advertisers, who participate in the auction in the resale service, check the predicted number of times by which an advertisement is viewed by users. As a result, the service providing apparatus 200 can provide value-added services for advertisers.

In addition, in the example described above, an example is illustrated in which the calculating unit 141 calculates the predicted number of PV based on the prediction element, such as “views of created content matched with a content creator of content being planned” or “views of created content matched with a category of content being planned”. However, the calculating unit 141 may calculate the predicted number of PV using a plurality of prediction elements.

For example, the calculating unit 141 may calculate the predicted number of PV based on “views of created content matched with a content creator of content being planned” and “views of created content matched with a category of content being planned”. An example where the calculating unit 141 generates a regression model (hereinafter, referred to as a “PV number model M1”) from both prediction elements and calculates the predicted number of PV from the generated PV number model M1 will be described below.

First, the calculating unit 141 generates the PV number model M1, which shows the predicted number of PV by the creator ID or the category, by performing a regression analysis using the views stored in the history information storage unit 222 as a dependent variable (objective variable) and the creator ID or the category stored in the history information storage unit 222 as an independent variable (explanatory variable). For example, the PV number model M1 calculated by the calculating unit 141 is expressed by the following Expression (1).

pv=a0·x0+a1·x1 (1)

In the above Expression (1), “pv” indicates views stored in the history information storage unit 222. In addition, “x0” indicates the average value of views for each creator ID. In the example of FIG. 21, the views of the created content “CD11” created by content creator CP11 is “115000”, and the views of the created content “CD12” created by content creator CP11 is “125000”. Therefore, “x0” corresponding to the content creator CP11 becomes “120000”. In addition, “x1” indicates the average value of views for each category. In the example of FIG. 21, the views of the created content “CD11” corresponding to the category “drama” is “115000”, and the views of the created content “CD21” corresponding to the category “drama” is “30000”. Therefore, “x1” corresponding to the category “drama” becomes “72500”.

For example, in the case of the created content “CD11” illustrated in FIG. 21, the views “pv” is “115000”. In addition, as in the example described above, “x0” corresponding to the content creator CP11 is “120000”, and “x1” corresponding to the category “drama” is “72500”. In this case, the above Expression (1) is expressed by the following Expression (2).

pv=a0·x0+a1·x1 (1)

115000=a0·(120000)+a1·(72500) (2)

Also for the created content “CD12” or “CD21”, the calculating unit 141 calculates the same expression as the above Expression (2). Then, the calculating unit 141 calculates “a0” and “a1”, which approximately satisfy each expression, by performing a regression analysis corresponding to each item of created content, and generates the PV number model M1 by applying the calculated “a0” and “a1” to the above Expression (1).

Then, when plan information is received by the plan receiving unit 131, the calculating unit 141 calculates the predicted number of PV using the PV number model M1 expressed by the above Expression (1). Specifically, the calculating unit 141 substitutes the average value of the views of created content corresponding to the content creator, who has transmitted the plan info nation, into “x0” in the above Expression (1). In addition, the calculating unit 141 substitutes the average value of the views of created content corresponding to the category included in the plan information into “x1” in the above Expression (1). In this manner, the calculating unit 141 calculates the predicted number of PV of the content shown by the plan information.

Thus, the service providing apparatus 200 can calculate the predicted number of PV with high accuracy by using a plurality of prediction elements. As a result, the service providing apparatus 200 can provide value-added services for advertisers.

In addition, in the above Expression (1), a linear model has been mentioned as an example. However, the calculating unit 141 may use a “log linear” model as in the following Expression (3) instead of the linear model.

pv=1/{1+exp(−(a0·x0+a1·x1))} (3)

5-13. Resale Mode

In addition, the service providing apparatus 100 described above may not hold an auction for all advertising spaces set by the content creator. Specifically, the plan receiving unit 131 may receive advertising space information including designation information in which an advertising space to be auctioned of a plurality of advertising spaces set on the content by the content creator is designated. In this case, the service providing unit 132 holds only an auction for the advertising space, which is designated as an object to be auctioned, based on the designation information. That is, the service providing unit 132 receives a bid for an advertising space designated as an object to be auctioned, and does not receive a bid for an advertising space that is not designated as an object to be auctioned. In this case, the service providing unit 132 also publishes information regarding the advertising space, which is not designated as an object to be auctioned, on the auction page. For example, the service providing unit 132 publishes the wording, such as “sold out” or “excluded”, for the advertising space that is not designated as an object to be auctioned. In addition, for example, advertisement data created by the content creator is incorporated into the advertising space that is not designated as an object to be auctioned, or no advertisement data is incorporated.

A content creator can hold the right to display an advertisement for the content creator himself or herself by excluding some advertising spaces from objects to be auctioned as described above. In addition, the content creator may transmit a request for the resale of the advertising space, which is held by the content creator himself or herself, to the service providing apparatus 100 after a finished product (that is, composite content) of the content is actually distributed. Thus, the content creator can obtain more funds, for example, by reselling the advertising space at the timing when the views of content are increased. In addition, in this example, the content creator can also determine user attributes for resale based on the distribution record of composite content. For example, the service providing apparatus 100 acquires the number of distributions for each targeting condition in each item of composite content from the distribution server 30 by periodically accessing the distribution server 30, and provides the acquired number of distributions for each targeting condition to the content creator. Therefore, the content creator can grasp the distribution regarding the user attributes of users who viewed the composite content. In addition, based on such a distribution record of composite content, the advertiser can set only the user attribute “female” for resale and the user attribute “male” not for resale.

5-14. Type of Content

In the above-described embodiments, the moving image is mainly given as an example of the content. However, the type of content is not limited to the moving image. Examples of the content may include applications, such as games, electronic books, and web pages, such as weblogs. For example, when the content creator plans to create games, electronic books, or professional web pages, the content creator can use the above-mentioned auction service.

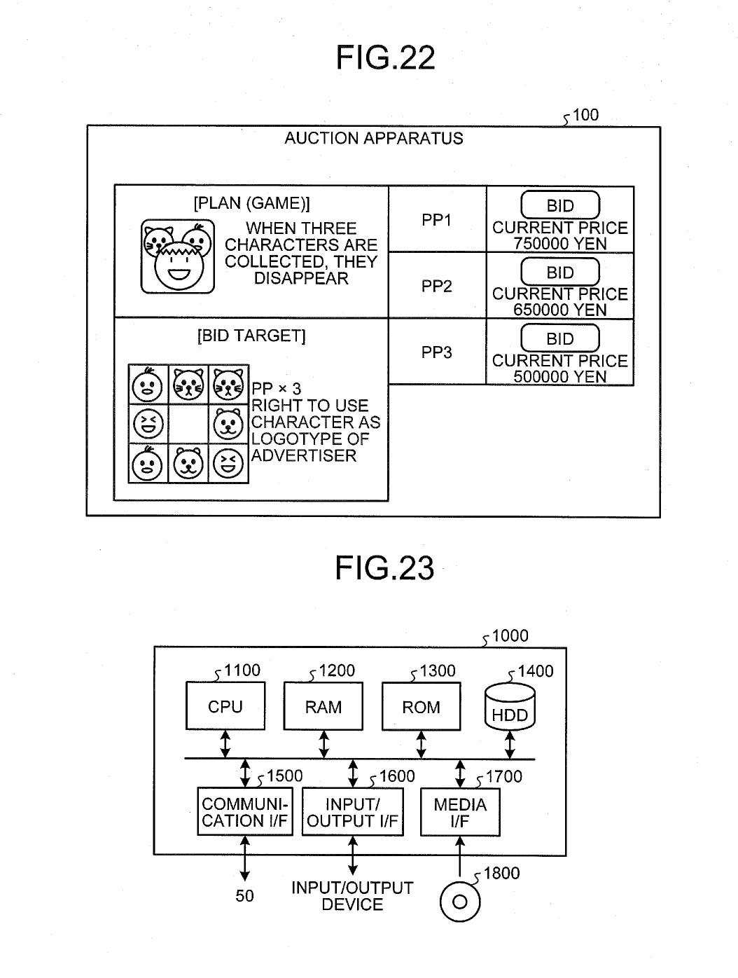

FIG. 22 illustrates an example of content according to another embodiment. FIG. 22 illustrates an example where the content is a game. In the example illustrated in FIG. 22, the content creator plans to create a game using character icons. The content creator sets three icons among plural types of icons as advertising spaces. As such, the above-mentioned auction service can also be applied to content, such as a game.

In addition, in the example of FIG. 22, similarly to the product placement, the content creator receives an icon image or the like for advertising from the advertiser, who is a winning bidder, and creates a game using the received icon image. As a result, the content creator creates composite content (in this example, a game) including advertisement data.

5-15. Program

In addition, the service providing apparatus 100 according to the embodiment described above is realized by a computer 1000 configured as illustrated in FIG. 23, for example. Hereinafter, the service providing apparatus 100 will be described as an example. FIG. 23 is a hardware block diagram illustrating an example of the computer 1000 to realize the function of the service providing apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400, and controls each unit. A boot program executed by the CPU 1100 at the start of the computer 1000, a program depending on the hardware of the computer 1000, and the like are stored in the ROM 1300.

The HDD 1400 stores a program executed by the CPU 1100 and data used by the program. The communication interface 1500 receives data from other apparatuses through the communication network 50 and transmits the data to the CPU 1100, and transmits the data generated by the CPU 1100 to other apparatuses through the communication network 50.

The CPU 1100 controls an output device, such as a display or a printer, and an input device, such as a keyboard or a mouse, through the input/output interface 1600. The CPU 1100 acquires data from an input device through the input/output interface 1600. In addition, the CPU 1100 outputs the generated data to an output device through the input/output interface 1600.

The media interface 1700 reads a program or data stored in a recording medium 1800, and provides it to the CPU 1100 through the RAM 1200. The CPU 1100 loads the program onto the RAM 1200 from the recording medium 1800 through the media interface 1700, executes the loaded program. The recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, when the computer 1000 functions as the service providing apparatus 100 according to the embodiment, the CPU 1100 of the computer 1000 realizes the function of the control unit 130 by executing the program loaded onto the RAM 1200. In addition, data in the auction storage unit 121 (or the auction storage unit 122 or the auction storage unit 123) is stored in the HDD 1400. The CPU 1100 of the computer 1000 reads these programs from the recording medium 1800 and executes them. However, as another example, these programs may be acquired from other apparatuses through the communication network 50.

5-16. Others

Among the respective processes described in the above embodiment, all or some of the processes described to be automatically performed can also be manually performed, or all or some of the processes described to be manually performed can also be automatically performed. In addition, information including the procedure, specific names, various kinds of data, or parameters, which are illustrated in the diagrams or specification described above, can be arbitrarily changed unless otherwise specified.

For example, the various kinds of information illustrated in the respective diagrams are not limited to the illustrated information. In addition, although the example where a plurality of advertising spaces are set on the same content is illustrated in each embodiment described above, one advertising space may be set on the same content, for example.

In addition, in the embodiment described above, an example is illustrated in which the content creator sets the reproduction position, reproduction time, or the like of the advertising space on the content. However, the service providing apparatus 100 may receive only plan information from the content creator, and may not receive advertising space information. In this case, the service providing apparatus 100 sets, for example, an advertising space of the reproduction position or reproduction time determined in advance on the content.

In addition, although the example where composite content obtained by incorporating advertisement data into content is distributed to the user terminal 40 is illustrated in each embodiment described above, for example, advertisement data may be distributed to the user terminal 40 by an advertisement server (called an ad server or the like), which is not illustrated in FIG. 2, whenever the content is displayed or reproduced by the user terminal 40. Specifically, the generating unit 135 of the service providing apparatus 100 may generate composite content by incorporating information on access (for example, URL: Uniform Resource Locator) to the advertisement server into the advertising space of content. In this case, the user terminal 40 accesses an advertisement server based on the access information set to the advertising space. Then, the advertisement server distributes the advertisement data incorporated into the content to the user terminal 40 when there is an access from the user terminal 40. In this case, the advertisement server selects advertisement data to be distributed, for example, based on the user attributes of the accessing user. Then, the user terminal 40 displays the advertisement data acquired from the advertisement server in the advertising space of the content. In addition, in this example, the advertiser may transmit access information for accessing a moving image, a still image, or the like, which is an advertisement, to the service providing apparatus 100 as advertisement data.

In addition, each component of each apparatus illustrated in the diagrams is a functional and conceptual component, and does not necessarily need to be physically configured as illustrated in the diagrams. That is, specific forms of distribution and integration of each apparatus are not limited to those illustrated in the diagrams, and all or some of distributed and integrated components may be configured to be distributed and integrated functionally or physically in arbitrary units depending on various types of loads, use conditions, or the like. For example, the plan receiving unit 131 and the content receiving unit 134 illustrated in FIG. 3 may be integrated. In addition, for example, the service providing apparatus 100 described above may be integrated with the distribution server 30.

In addition, the respective embodiment described above can be appropriately combined to the extent that the processing content is consistent. For example, the embodiment for reselling a part of the advertising right illustrated in FIGS. 9 to 14 and the embodiment illustrated in FIG. 15 can be combined. In this case, in step S23 illustrated in FIG. 15, the service providing unit 132 notifies the content creator of winning bidder information and information regarding an object for resale (the number of PV, distribution period, user attributes, and the like).

6. Effect

As described above, the service providing apparatus 100 according to the embodiment includes the request receiving unit 137 and the service providing unit 132. The request receiving unit 137 receives, from an advertiser having the right to display an advertisement on content, a resale request to resell a right to be resold to other advertiser. The service providing unit 132 provides a resale service (for example, an auction service) for reselling the right to be resold when the resale request is received by the request receiving unit 137.

In this manner, the service providing apparatus 100 according to the embodiment can provide value-added services for both an advertiser who has acquired the advertising right and an advertiser who has not acquired the advertising right.

In addition, in the service providing apparatus 100 according to the embodiment, the request receiving unit 137 receives the resale request to resell the right to be resold, which is a part of the right to display an advertisement on the content, to display an advertisement by a predetermined number of times (for example, the number of PV). In addition, the service providing unit 132 provides the resale service for reselling the right to be resold.

Therefore, the service providing apparatus 100 according to the embodiment can provide high value-added services for advertisers.

In addition, in the service providing apparatus 100 according to the embodiment, the request receiving unit 137 receives the resale request to resell the right to be resold, which is a part of the right to display an advertisement on the content, to display an advertisement in a predetermined period of time. In addition, the service providing unit 132 provides the resale service for reselling the right to be resold.

Therefore, the service providing apparatus 100 according to the embodiment can provide high value-added services for advertisers.

In addition, in the service providing apparatus 100 according to the embodiment, the request receiving unit 137 receives the resale request to resell the right to be resold, which is a part of the right to display an advertisement on the content, to display an advertisement on the content distributed to a predetermined distribution destination. In addition, the service providing unit 132 provides the resale service for reselling the right to be resold.

Therefore, the service providing apparatus 100 according to the embodiment can provide high value-added services for advertisers.

In addition, in the service providing apparatus 100 according to the embodiment, the service providing unit 132 notifies a content creator, who creates the content, of the information regarding the resale destination when the resale destination which is purchaser of the right to be resold is determined.

In this manner, the service providing apparatus 100 according to the embodiment can make the content creator check the advertiser of the resale destination whenever the advertising right is resold. As a result, it is possible to provide value-added services not only for advertisers but also for content creators.

In addition, in the service providing apparatus 100 according to the embodiment, the service providing unit 132 receives permission information, which indicates whether or not to allow the resale of the right to the resale destination, from the content creator and determines whether or not to resell the right to be resold to the resale destination according to the permission information.

In this manner, the service providing apparatus 100 according to the embodiment makes the content creator determine whether or not the advertiser of the resale destination is appropriate. As a result, it is possible to provide value-added services not only for advertisers but also for content creators.

In addition, in the service providing apparatus 100 according to the embodiment, the request receiving unit 137 receives the resale request from the advertiser having the right to display an advertisement in some of a plurality of advertising spaces set on the content. In addition, the service providing unit 132 presents information regarding the plurality of advertising spaces, and provides the resale service in response to the resale request received by the request receiving unit 137.

In this manner, the service providing apparatus 100 according to the embodiment can provide information, which will be helpful at the time of bidding, to advertisers participating in the resale service. As a result, it is possible to provide value-added services for advertisers.

In addition, in the service providing apparatus 100 according to the embodiment, when the resale request is received by the request receiving unit 137, the service providing unit 132 provides the content creator who creates the content with the resale service for reselling the right to be resold.

In this manner, the service providing apparatus 100 according to the embodiment can make the content creator repurchase the advertising right. As a result, it is possible to provide value-added services not only for advertisers but also for content creators.

In addition, the service providing apparatus 100 according to the embodiment includes the plan receiving unit 131 that receives, from a content creator who creates content, plan information indicating a plan of the content. In addition, the service providing unit 132 presents the plan information received by the plan receiving unit 131, and provides a sales service (for example, an auction service) for selling the right to display an advertisement on content. In addition, the request receiving unit 137 receives a resale request from an advertiser who purchases the right in the sales service.

Thus, the service providing apparatus 100 according to the embodiment can provide an advertiser, which has made a successful bid in the planning stage of content, with the resale service for reselling thee advertising right. For example, depending on the advertiser who has made a successful bid for the advertising right in the planning stage, the content imaged in the planning stage and the completed content may be different. Since the service providing apparatus 100 can make such an advertiser resell the advertising right, it is possible to provide value-added services.

In addition, in the service providing apparatus 100 according to the embodiment, the plan receiving unit 131 receives advertising conditions regarding the advertisement displayed on the content from the content creator. In addition, the service providing unit 132 provides a sales service and a resale service in a range where the advertising conditions received by the plan receiving unit 131 are satisfied.

In this manner, the service providing apparatus 100 according to the embodiment can make the content creator select an advertiser, who matches the image of content, in advance. As a result, it is possible to provide value-added services not only for advertisers but also for content creators.

In addition, in the service providing apparatus 100 according to the embodiment, when a resale request is received by the request receiving unit 137, the service providing unit 132 transmits a relaxation request for the relaxation of the advertising conditions to the content creator, and determines to pay the content creator a predetermined commission when the advertising conditions are relaxed by the content creator.

In addition, in the service providing apparatus 100 according to the embodiment, the service providing unit 132 determines a part or all of the fees, which are obtained from advertisers using the resale service, as a commission paid to the content creator.

Therefore, since it is possible to relax the limitation on advertisers, the service providing apparatus 100 according to the embodiment can provide value-added services for advertisers.

In addition, the above-described sections, modules, units can be read as “means”, “circuits”, and the like. For example, the plan receiving unit can be read as a plan receiving unit or a planning receiving circuit.

According to an aspect of the embodiment, there is an effect that it is possible to provide value-added services for advertisers.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A service providing apparatus, comprising:
a request receiving unit configured to receive, from an advertiser having a right to display an advertisement on content, a resale request to resell a right to be resold to other advertiser; and
a providing unit configured to provide a resale service for reselling the right to be resold when the resale request is received by the request receiving unit.

2. The service providing apparatus according to claim 1,
wherein the request receiving unit receives the resale request to resell the right to be resold, which is a part of the right to display an advertisement on the content, to display an advertisement by a predetermined number of times, and
the providing unit provides the resale service for reselling the right to be resold.

3. The service providing apparatus according to claim 1,
wherein the request receiving unit receives the resale request to resell the right to be resold, which is a part of the right to display an advertisement on the content, to display an advertisement in a predetermined period of time, and
the providing unit provides the resale service for reselling the right to be resold.

4. The service providing apparatus according to claim 1,
wherein the request receiving unit receives the resale request to resell the right to be resold, which is a part of the right to display an advertisement on the content, to display an advertisement on the content distributed to a predetermined distribution destination, and
the providing unit provides the resale service for reselling the right to be resold.

5. The service providing apparatus according to claim 1,
wherein, when a resale destination which is purchaser of the right to be resold is determined, the providing unit notifies a content creator, who creates the content, of information regarding the resale destination.

6. The service providing apparatus according to claim 5,
wherein the providing unit receives permission information, which indicates whether or not to allow resale to the resale destination, from the content creator, and determines whether or not resell the right to be resold to the resale destination according to the permission information.

7. The service providing apparatus according to claim 1,
wherein the request receiving unit receives the resale request from the advertiser having a right to display an advertisement in some of a plurality of advertising spaces set on the content, and
the providing unit presents information regarding the plurality of advertising spaces, and provides the resale service in response to the resale request received by the request receiving unit.

8. The service providing apparatus according to claim 1,
wherein, when the resale request is received by the request receiving unit, the providing unit provides a content creator who creates the content with the resale service for reselling the right to be resold.

9. The service providing apparatus according to claim 1,
wherein the providing unit provides the resale service through an auction.

10. The service providing apparatus according to claim 1, further comprising:
a plan receiving unit configured to receive plan information indicating a plan of a content from a content creator who creates the content,
wherein the providing unit presents the plan information received by the plan receiving unit and provides a sales service for selling the right to display an advertisement on the content, and
the request receiving unit receives the resale request from the advertiser who purchases the right in the sales service.

11. The service providing apparatus according to claim 10,
wherein the plan receiving unit receives advertising conditions regarding an advertisement displayed on the content from the content creator, and
the providing unit provides the sales service and the resale service in a range where the advertising conditions received by the plan receiving unit are satisfied.

12. The service providing apparatus according to claim 11,
wherein the providing unit transmits a relaxation request for relaxation of the advertising conditions to the content creator when the resale request is received by the request receiving unit, and determines to pay the content creator a predetermined commission when the advertising conditions are relaxed by the content creator.

13. The service providing apparatus according to claim 10, further comprising:
a calculating unit configured to calculate a predicted value of the number of times, by which content corresponding to the plan information is viewed by users, based on the plan information when the plan information is received by the plan receiving unit,
wherein the providing unit presents the predicted value calculated by the calculating unit, and provides the sales service.

14. The service providing apparatus according to claim 10,
wherein the providing unit provides the sales service through an auction.

15. A service providing method executed by a computer, comprising:
receiving, from an advertiser having a right to display an advertisement on content, a resale request to resell a right to be resold to other advertisers; and
providing a resale service for reselling the right to be resold when the resale request is received at the receiving.

16. A non-transitory computer-readable storage medium with an executable program stored thereon, wherein the program instructs a computer to perform:
receiving, from an advertiser having a right to display an advertisement on content, a resale request to resell a right to be resold to other advertisers; and
providing a resale service for reselling the right to be resold when the resale request is received at the receiving.
